(19) United States
(12) Patent Application Publication
(10) Pub. No.: US 2007/0109225 A1
(43) Pub. Date: May 17, 2007

(54) Plasma display apparatus and method for driving the same

(75) Inventors: Jung Gwan Han, Gumi-si (KR); Seongho Kang, Buk-gu (KR)

Correspondence Address: KED & ASSOCIATES, LLP, P.O. Box 221200, Chantilly, VA, 20153-1200, US

(73) Assignee: LG Electronics Inc.

(21) Appl. No.: 11/407,908

(22) Filed: Apr. 21, 2006

(30) Foreign Application Priority Data
Nov. 11, 2005 (KR) 10-2005-0108010

(51) Int. Cl. G09G 3/28

(52) U.S. Cl. 345/67

(57) ABSTRACT

This document relates to a plasma display apparatus, and more particularly, to a plasma display apparatus that drives electrodes and a method for driving the same. A plasma display apparatus according to an embodiment of the present invention comprises a panel comprising a plurality of address electrodes and a driver for applying a first data pulse and a second data pulse, which are different from each other, to the plurality of address electrodes. The method for driving a plasma display apparatus according to an embodiment of the present invention comprises the steps of applying a first data pulse and a different second data pulse to an address electrode during an address period and applying sustain pulses to sustain electrodes after the address period.

This Nonprovisional application claims priority under 35 U.S.C. § 119(a) on patent application No. 2005-0108010 filed in Korea on Nov. 11, 2005 the entire contents of which are hereby incorporated by reference.

### BACKGROUND OF THE INVENTION

1. Field of the Invention

This document relates to a plasma display apparatus, and more particularly, to a plasma display apparatus that drives electrodes and a method for driving the same.

2. Background of the Related Art

Generally, among display devices, a plasma display apparatus comprises a plasma display panel and a driver for driving the plasma display panel.

Generally, in a plasma display panel, barrier ribs formed between a front panel and a rear panel constitute a single discharge cell. A main discharge gas, such as neon (Ne), helium (He) or a mixed gas (Ne+He) of Ne and He, and an inert gas containing a small amount of xenon (Xe) are filled in each discharge cell.

A plurality of such discharge cells constitutes a single pixel. For example, a red discharge cell R, a green discharge cell G and a blue discharge cell B constitute a single pixel.

When discharged by a high frequency voltage, the inert gas generates vacuum ultraviolet rays to radiate a phosphor material formed between the barrier ribs, thus implementing an image.

Such a plasma display panel has an advantage of thin and lightweight design, and accordingly the plasma display panel has been spotlighted as a next-generation display device.

The plasma display panel has a plurality of electrodes, for example, scan electrodes Y, sustain electrodes Z and address electrodes X. A driving voltage is supplied to these electrodes to generate a discharge, thereby displaying an image.

A driver integrated circuit is connected to the electrodes in order to supply a driving voltage to the electrodes of the plasma display panel.

For instance, among the electrodes of the plasma display panel, the address electrode X is connected with a data driver integrated circuit, and the scan electrode Y is connected with a scan driver integrated circuit.

As above, an apparatus comprising a plasma display panel having a plurality of electrodes and a driver for supplying a driving voltage to the plurality of electrodes of the plasma display panel is called a plasma display apparatus.

Here, switching devices used for conventional data driver integrated circuits for supplying a driving voltage to the address electrode X of the plasma display panel generate a relatively high heat upon driving.

For instance, it is assumed that a data voltage Vd supplied by a data voltage source is 60V. And, it is assumed that the resistance of each switching device is R.

In this case, when a data voltage Vd is supplied to the address electrode via a data driver integrated circuit, the current flowing through a single switching device and the power consumed in the switching device are defined by the following mathematical formula 1:

[Mathematical Formula]
i=60V/R
W=i×60V

wherein i denotes the current flowing through a single switching device, and W denotes the power consumed in a single switching device.

In Mathematical Formula 1, it can be seen that the aforementioned switching device consumes a power of i×60V upon driving. At this time, the switching device generates heat in proportion to the power consumption W. For example, if it is assumed that the resistance R of the switching device is 30Ω (Ohm), the switching device generates heat of (60/30)×60=120 W.

Such a switching device supplies a data pulse of a data voltage Vd a plurality of times to the address electrode in an address period of a single subfield.

For instance, in a case that a number of discharge cells arranged on the address electrode is 100, a single switching device supplies a data pulse of a data voltage Vd to the address electrode a total of a maximum of 100 times in an address period of a single subfield.

Then, the single switching device in the address period of the single subfield generates heat of a total of a maximum of (60/30)×60×100=1200 W.

Moreover, in a case that image data has a specific pattern in which logic values of 1 and 0 are repeated, there is a problem that an excessively high heat is generated at the switching device of the data driver integrated circuit, thus causing damage like burning the switch or the like.

### SUMMARY OF THE INVENTION

Accordingly, an object of an embodiment of the present invention is to solve at least the problems and disadvantages of the background art.

It is an object of an embodiment of the present invention to improve operational stability by preventing thermal and electrical damages of a data driver integrated circuit.

To achieve the above objects, a plasma display apparatus according to an embodiment of the present invention comprises a panel comprising a plurality of address electrodes and a driver for applying a first data pulse and a second data pulse, which are different from each other, to the plurality of address electrodes.

A plasma display apparatus according to an embodiment of the present invention comprises a panel comprising a plurality of address electrodes and a driver for applying data pulses to a plurality of address electrode groups, into which the plurality of address electrodes are divided, and making a N-th (N is a natural number) data pulse among the data pulses supplied to at least one of the address electrode groups different from a N-th data pulse among the data pulses supplied to the other address electrode groups.

A method for driving a plasma display apparatus according to an embodiment of the present invention comprises the steps of applying a first data pulse and a second data pulse different from the first data pulse to an address electrode during an address period and applying sustain pulses to sustain electrodes after the address period.

By adding an energy recovery circuit to a driver for supplying data pulses, preferably, a data driver, and driving the same, the present invention can improve operational stability of the entire plasma display apparatus by preventing heat generated upon driving from being concentrated on a specific switching device, preferably, a data driver integrated circuit and preventing thermal and electrical damages of the data driver integrated circuit.

The present invention can lower manufacturing costs by enabling a stable operation even if the withstand voltage characteristics of the data driver integrated circuit are lowered,

The present invention can lower manufacturing costs because the volume and/or surface area of a heat sink for releasing heat generated from the data driver integrated circuit can be relatively smaller when compared with the conventional art.

### BRIEF DESCRIPTION OF THE DRAWINGS

The embodiment of the invention will be described in detail with reference to the following drawings in which like numerals refer to like elements:

FIG. 1 is a view for explaining a plasma display apparatus according to an embodiment of the present invention;

FIG. 2 is a view for explaining one example of a structure of a plasma display panel of the plasma display apparatuses according to an embodiment of the present invention;

FIG. 3 is a view for explaining a frame for representing the gray levels of an image in the plasma display apparatus according to an embodiment of the present invention;

FIG. 4 is a view for explaining the operation of a driver comprising a data driver, a scan driver and a sustain driver in the plasma display apparatus according to an embodiment of the present invention;

FIGS. 5a to 5c are views for explaining in more detail the operation of the driver in the plasma display apparatus according to an embodiment of the present invention;

FIG. 6 is a view for explaining a method of determining the voltage rising period and falling period of a data pulse;

FIGS. 7a and 7b are views for explaining one example of a method of differentiating the voltage rising period and falling period of a data pulse;

FIG. 8 is a view for explaining another method for supplying a data pulse having a relatively long voltage rising period and/or falling period;

FIG. 9 is a view for explaining yet another method for supplying a data pulse having a relatively long voltage rising period and/or falling period;

FIG. 10 is a view for explaining the construction of the data driver of the plasma display apparatus according to an embodiment of the present invention;

FIGS. 11a to 11c are views for explaining the operation of the data driver of FIG. 10;

FIGS. 12a to 12c are another views for explaining the operation of the data driver of FIG. 10;

FIG. 13 is a view for explaining one example of a method for dividing a plurality of address electrodes formed on the plasma display panel into two address electrode groups;

FIG. 14 is a view showing one example of a method for dividing the address electrodes formed on the plasma display panel into four address electrode groups;

FIG. 15 is a view for explaining one example of dividing the address electrodes X formed on the plasma display panel into one or more address electrode groups, each comprising a different number of address electrodes X;

FIG. 16 is a view for explaining the operation of the plasma display apparatus according to an embodiment of the present invention in a case that the plurality of address electrodes X is divided into two address electrode groups;

FIG. 17 is a view for explaining the construction of the driver for supplying data pulses of different patterns to two address electrode groups;

FIG. 18 is a view for explaining the operation of the plasma display apparatus according to an embodiment of the present invention in a case that the plurality of address electrodes X is divided into three or more address electrode groups;

FIG. 19 is a view for explaining the construction of the driver for supplying data pulses of different patterns to four address electrode groups;

FIG. 20 is a view for explaining one example of a structure employing a heat sink in order to emit heat of the data driver integrated circuit upon driving the plasma display apparatus according to an embodiment of the present invention;

FIG. 21 is a view for explaining one example of a structure of a heat sink for releasing heat generated from the data driver integrated circuit of the plasma display apparatus according to an embodiment of the present invention; and

FIG. 22 is a view for explaining another example of a structure of a heat sink for releasing heat generated from the data driver integrated circuit of the plasma display apparatus according to an embodiment of the present invention.

### DETAILED DESCRIPTION OF THE PREFERRED EMBODIMENTS

Embodiments of the present invention will be described in a more detailed manner with reference to the drawings.

A plasma display apparatus according to an embodiment of the present invention comprises a panel comprising a plurality of address electrodes and a driver for applying a first data pulse and a second data pulse, which are different from each other, to the plurality of address electrodes.

The first data pulse and the second data pulse are applied in the same subfield.

The voltage rising period and/or falling period of the second data pulse is more than the voltage rising period and/or falling period of the first data pulse.

A plasma display apparatus according to an embodiment of the present invention comprises a panel comprising a plurality of address electrodes and a driver for applying data pulses to a plurality of address electrode groups, into which the plurality of address electrodes are divided, and making a N-th (N is a natural number) data pulse among the data pulses supplied to at least one of the address electrode groups different from a N-th data pulse among the data pulses supplied to the other address electrode groups.

The N-th (N is a natural number) data pulse among the data pulses supplied to at least one of the address electrode groups and the N-th data pulse among the data pulses supplied to the other address electrode groups may be applied in different subfields.

The voltage falling period and/or rising period of the N-th (N is a natural number) data pulse among the data pulses supplied to at least one of the address electrode groups is different from the voltage falling period and/or rising period of the N-th data pulse among the data pulses supplied to the other address electrode groups.

The voltage rising period of the N-th (N is a natural number) data pulse among the data pulses supplied to at least one of the address electrode groups is the time taken for the voltage of the data pulse to rise from 10% of the highest voltage to 90% of the highest voltage, and the voltage falling period of the N-th (N is a natural number) data pulse among the data pulses supplied to at least one of the address electrode groups is the time taken for the voltage of the data pulse to fall from 90% of the highest voltage to 10% of the highest voltage.

The plurality of address electrode groups each comprises the same number of address electrodes.

The number of address electrode groups ranges from four to eight.

The number of address electrode groups is M (M is a natural number of two or more), and the voltage falling period and/or rising period of the N-th (N is a natural number) data pulse among the data pulses supplied to one of the M number of address electrode groups is different from the voltage falling period and/or rising period of the N-th data pulse among the data pulses supplied to the other M−1 number of address electrode groups.

The voltage falling period and/or rising period of the N-th (N is a natural number) data pulse among the data pulses supplied to one of the M number of address electrode groups is more than the voltage falling period and/or rising period of the N-th data pulse among the data pulses supplied to the other M−1 number of address electrode groups.

The address electrode groups comprises a first address electrode group and a second address electrode group, and the voltage falling period and/or rising period of the N-th data pulse among the data pulses supplied to the first address electrode group is more than the voltage falling period and/or rising period of the N-th data pulse among the data pulses supplied to the second address electrode group.

The voltage falling period and/or rising period of the N-th data pulse among the data pulses supplied to the first address electrode group is substantially equal to the voltage falling period and/or rising period of sustain pulses supplied to sustain electrodes in a sustain period after the address period

The voltage falling period and/or rising period of the N-th data pulse among the data pulses supplied to the first address electrode group are different from each other.

The voltage falling period and/or rising period of the N-th data pulse among the data pulses supplied to the first address electrode group are substantially equal to each other.

A method for driving a plasma display apparatus according to an embodiment of the present invention comprises the steps of applying a first data pulse and a second data pulse different from the first data pulse to an address electrode during an address period and applying sustain pulses to sustain electrodes after the address period.

The first data pulse and the second data pulse are applied in the same subfield.

The voltage rising period and/or falling period of the first data pulse is different from the voltage rising period and/or falling period of the second data pulse.

The voltage rising period and/or falling period of the second data pulse is more than the voltage rising period and/or falling period of the first data pulse.

The voltage rising period of the second data pulse is the time taken for the voltage of the data pulse to rise from 10% of the highest voltage to 90% of the highest voltage, and the voltage falling period of the second data pulse is the time taken for the voltage of the data pulse to fall from 90% of the highest voltage to 10% of the highest voltage.

Detailed embodiments of the present invention will now be described in connection with reference to the accompanying drawings.

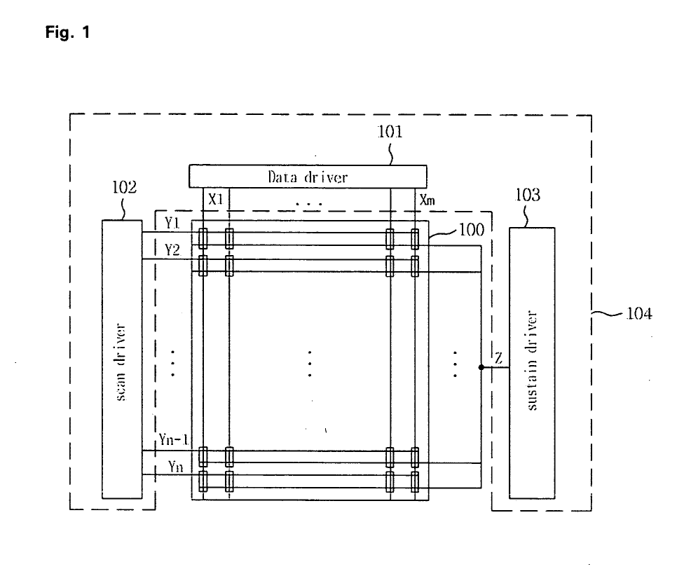

FIG. 1 is a view for explaining a plasma display apparatus according to an embodiment of the present invention.

As illustrated in FIG. 1, the plasma display apparatus according to an embodiment of the present invention comprises a plasma display panel 100 and a driver 104.

The plasma display panel 100 preferably has a front panel (not shown) and a rear panel (not shown) joined together at regular intervals and a plurality of electrodes, for example, a plurality of address electrodes X.

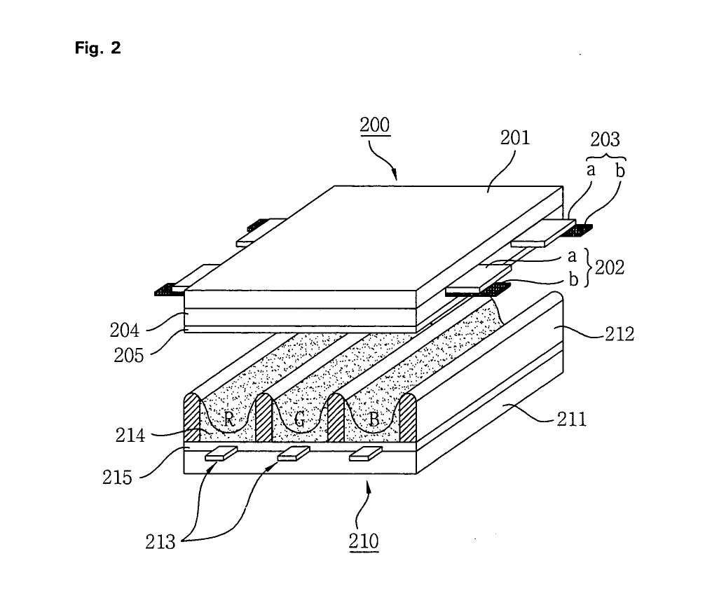

The structure of such a plasma display panel 100 will now be described in more detail with reference to FIG. 2.

FIG. 2 is a view for explaining one example of a structure of a plasma display panel of the plasma display apparatuses according to an embodiment of the present invention.

As illustrated in FIG. 2, the plasma display panel 100 of the plasma display apparatus according to an embodiment of the present invention has a front panel 200 and a rear panel 210 coupled in parallel with each other at a predetermined distance therebetween, the front panel 200 having sustain electrodes comprising scan electrodes 202, Y and sustain electrodes 203, Z formed on a front substrate 201 which is a display surface for displaying an image, and the rear panel 210 having a plurality of address electrodes 213, X arranged on a rear substrate 211 constituting the rear surface, for intersecting the sustain electrodes comprising the scan electrodes 202, Y and the sustain electrodes 203, Z.

The front panel 200 comprises sustain electrodes comprising scan electrodes 202, Y and sustain electrodes 203, Z, for discharging in one discharge space, i.e., in one discharge cell, and maintaining the light emission of the discharge cell, that is, sustain electrodes composed of pairs of scan electrodes 202, Y and sustain electrodes 203, Z, provided as transparent electrodes (a) formed of transparent ITO material and bus electrodes (b) made of metal.

The sustain electrodes comprising the scan electrodes 202, Y and sustain electrodes 203, Z, are covered by at least one upper dielectric layer 204 for restricting a discharge current and insulating between the pairs of electrodes, and has a protective layer 205 formed on the top surface of the upper dielectric layer 204, being deposited with magnesium dioxide (MgO) for making the discharge condition easier.

Stripe type (or well type) barrier ribs 212 for forming a plurality of discharge spaces, i.e., discharge cells are arranged in parallel on the rear panel 210. Further, a plurality of address electrodes 213 arranged in parallel with the barrier ribs 212, for generating vacuum ultraviolet rays by an address discharge.

RGB phosphors 214 are coated on the upper side of the rear panel 210, to emit visible light for displaying images at the time of address discharge. A lower dielectric layer 215 is formed between the address electrodes 213, X and the phosphors 214, for protecting the address electrodes 213, X.

FIG. 2 is illustrative and explanatory of only one example of the plasma display panel to which the invention may be applied, it should be noted that this invention is not limited to the plasma display panel of the structure of FIG. 2.

For instance, while FIG. 2 illustrates the scan electrodes 202, Y, sustain electrodes 203, Z, and address electrodes 213, X being formed on the plasma display panel 100, one or more of the scan electrodes 202, Y, and sustain electrodes 203, Z may be omitted from the electrodes of the plasma display panel 100 that is applied to the plasma display apparatus according to an embodiment of the present invention.

In other words, although FIG. 2 has illustrated only the case where the sustain electrodes comprise scan electrodes 202, Y and sustain electrodes 203, Z, it may also possible that the sustain electrodes comprise either scan electrodes 202, Y, or sustain electrodes 203, Z.

Furthermore, although FIG. 2 has illustrated the scan electrodes 202, Y and sustain electrodes 203, Z being composed of transparent electrodes (a) and bus electrodes (b), respectively, it may also possible that either or both of the scan electrodes 202, Y and sustain electrodes 203, Z is composed of only bus electrodes (b).

Furthermore, although the illustration and explanation are made with respect to the case where the scan electrodes 202, Y and sustain electrodes 203, Z are included in the front panel 200 and the address electrodes 213, X are included in the rear panel 210, it also may be possible that all of the electrodes are formed on the front panel 200 or at least either the scan electrodes 202, Y, sustain electrodes 203, Z or address electrodes 213 are formed on the barrier ribs 212.

Putting the explanations of FIG. 2 together, it can be seen that the plasma display panel to which this invention is applicable has a plurality of address electrodes 213, X for supplying a driving voltage, and other conditions are not particularly limited.

Here, the description of FIG. 2 will be summed up, and the description of FIG. 1 will be continued.

The aforementioned driver 104 drives a plurality of electrodes in a method of supplying a driving voltage to the plurality of electrodes formed on the plasma display panel 100 in one or more subfields included in one frame.

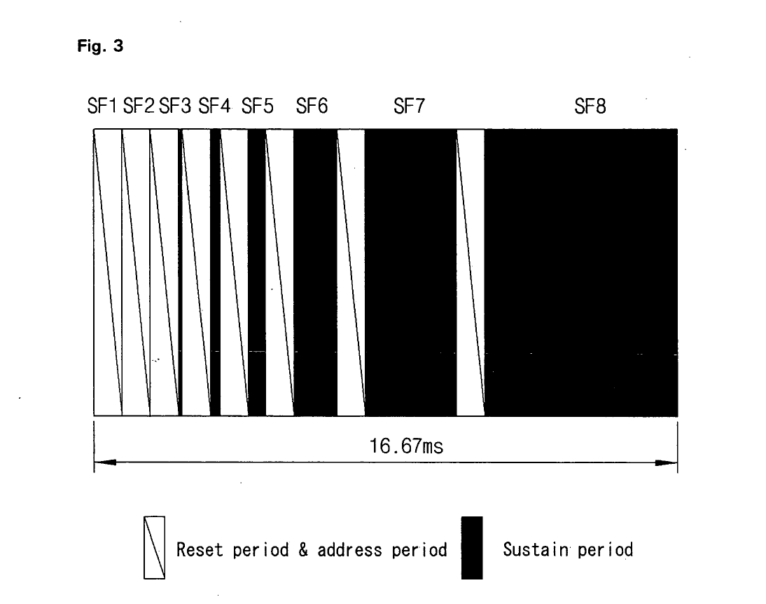

Here, one example of a structure of a frame for driving the plurality of electrodes of the plasma display panel 100 will be described in more detail with reference to FIG. 3.

FIG. 3 is a view for explaining a frame for representing the gray levels of an image in the plasma display apparatus according to an embodiment of the present invention.

As illustrated in FIG. 3, in the plasma display apparatus according to an embodiment of the present invention, in order to implement the gray level of an Image, one frame is divided into several subfields having different numbers of emission.

Although not shown, each of the subfields is divided into a reset period RPD for initializing every discharge cell, an address period APD for selecting a discharge cell, and a sustain period SPD for displaying gray levels according to the number of discharge times.

For example, if a picture is to be represented using 256 gray levels, a frame period (16.67 ms) corresponding to ( 1/60 second is divided into eight subfields SF1 to SF8. Also, each of the eight subfields SF1 to SF8 is divided into a reset period, an address period and a sustain period.

In the above, the reset period and the address period of each of the subfields are the same every subfields.

Further, a data discharge for selecting a discharge cell occurs by a voltage difference between the address electrode X and the scan electrode Y.

The sustain period is a period for determining a weighted gray level in each of the subfields.

For instance, a weighted gray level of each of the subfields can be determined so that the weighted gray level of each of the subfields increases in the ratio of 2ⁿ (n=0, 1, 2, 3, 4, 5, 6, 7) in such a manner that the weighted gray level of the first subfield is set to 2⁰ and the weighted gray level of the second subfield is set to 2¹.

As above, gray levels of various images can be represented by adjusting the number of sustain pulses supplied in the sustain period of each subfield according to the weighted gray level in the sustain period of each subfield.

Such a plasma display apparatus of this invention uses a plurality of frames in order to display one second of an image. For instance, 60 frames are used in order to display one second of an image.

Although FIG. 3 has illustrated and explained the case where one frame is composed of 8 subfields, the number of subfields of one frame may be changed in various ways.

For instance, one frame may be constructed of 12 subfields from the first subfield to twelfth subfield, or one frame may be constructed of 10 subfields.

The picture quality of an image represented by the plasma display apparatus representing a gray level of the image in a frame can be determined according to the number of subfields included in the frame.

That is to say, if the number of subfields included in a frame is 12, 2¹² gray levels of an image can be represented, and if the number of subfields included in a frame is 8, 2⁸ gray levels of an image can be represented.

Although, in FIG. 3, the subfields are arranged in the order of increasing weighted gray levels in one frame, the subfields may be arranged in the order of decreasing weighted gray levels in one frame or the subfields may be arranged regardless of weighted gray levels.

Here, the description of FIG. 3 will be summed up, and the description of FIG. 1 will be continued.

The construction of the driver 104 for driving a plurality of electrodes of the plasma display panel 100 in one or more subfields of the frame as shown in FIG. 3 may be varied according to the electrodes formed on the plasma display panel 100.

In the above, in a case where scan electrodes Y and sustain electrodes in parallel with the scan electrodes Y and address electrodes X intersecting the scan electrodes Y and the sustain electrodes Z are formed on the plasma display panel 100, it is preferred that the driver 104 comprises a data driver 101, a scan driver 102, and a sustain driver 103.

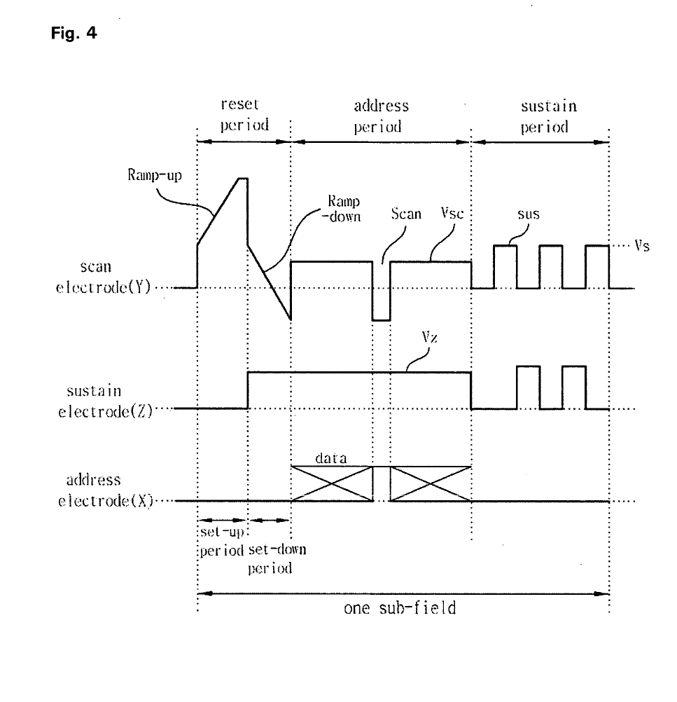

The operation of the driver 104 when the driver 104 comprises a data driver 101, a scan driver 102 and a sustain driver 103 will be described with reference to FIG. 4.

FIG. 4 is a view for explaining the operation of a driver comprising a data driver, a scan driver and a sustain driver in the plasma display apparatus according to an embodiment of the present invention.

As illustrated in FIG. 4, the driver 104 supplies a driving voltage to the address electrodes X, scan electrodes Y and sustain electrodes Z in the reset period, address period and sustain period of one subfield.

Such a driver 304 supplies a rising waveform Ramp-up to the scan electrodes in a set-up period of the reset period as shown in FIG. 4. Preferably, the scan driver 102 of the driver 104 supplies a ramp-up waveform Ramp-up to the scan electrodes Y.

A weak dark discharge is generated within the cells of the whole screen by means of the rising waveform Ramp-up. The set-up discharge causes a wall charge of the positive (+) polarity to be accumulated on the address electrodes X and the sustain electrode Z, and a wall charge of the negative (−) polarity to be accumulated on the scan electrodes Y.

In a set-down period as shown in FIG. 4, after the rising waveform Ramp-up is supplied, the driver 104, preferably, the scan driver 102 of the driver 104, supplies to the scan electrodes Y a falling waveform Ramp-down that starts to fall from a voltage of the positive polarity lower than a peak voltage of the rising waveform Ramp-up to a ground voltage GND or a specific voltage level of the negative polarity.

The falling ramp waveform Ramp-down causes a weak erasure discharge within the cells to erase a portion of excessively formed wall charges. Wall charges enough to generate a stable address discharge are uniformly left within the cells with the aid of the set-down discharge.

In the address period as shown in FIG. 4, the driver 104, preferably, the scan driver 102 of the driver 104, supplies to the scan electrodes Y a scan pulse of the negative polarity falling from a scan reference voltage Vsc. At the same time, the driver 104, preferably, the scan driver 102 of the driver 104, supplies to the address electrodes X a data pulse of the positive polarity in synchronization with the scan pulse.

A voltage difference between the scan pulse and the data pulse is added to a wall voltage generated in the reset period to thereby generate an address discharge within the cells supplied with the data pulse.

Wall charges enough to cause a discharge when a sustain voltage is applied are formed within the cells selected by the address discharge. Accordingly, the scan electrodes Y are scanned.

In the sustain period after the address period, the driver 104 alternately supplies a sustain pulse SUS to either or both of the scan electrodes Y and the sustain electrodes Z. Preferably, the scan driver 102 and sustain driver 103 of the driver 104 alternately supply a sustain pulse SUS to the scan electrodes Y and sustain electrodes Z, respectively.

Then, a wall voltage within the cell selected by the address discharge is added to the sustain pulse SUS to thereby generate a sustain discharge, that is, a display discharge between the scan electrode Y and the sustain electrode Z whenever the sustain pulse SUS is applied.

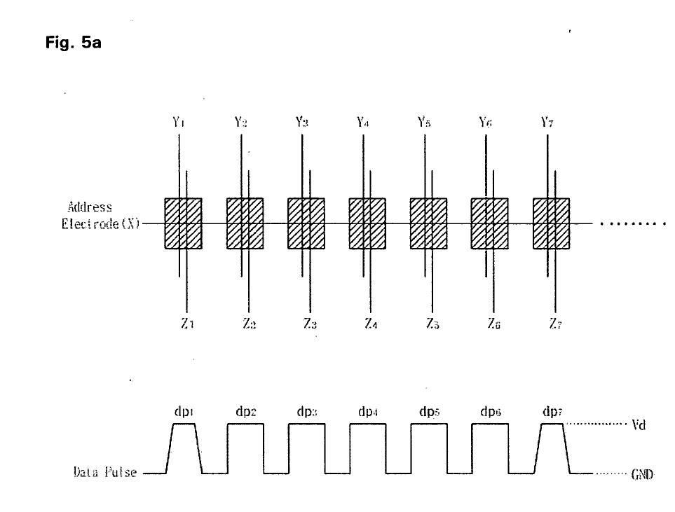

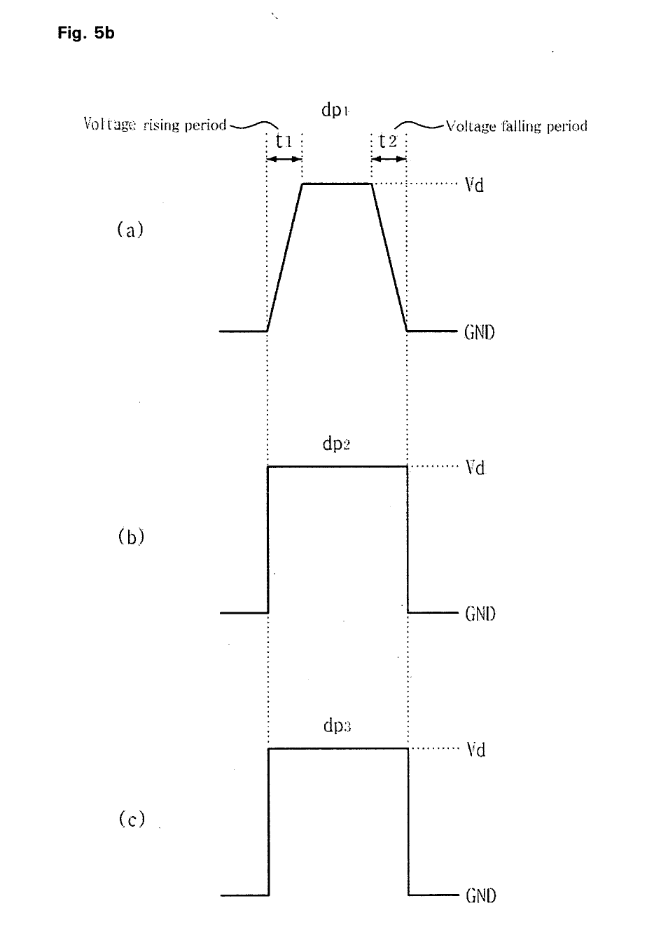

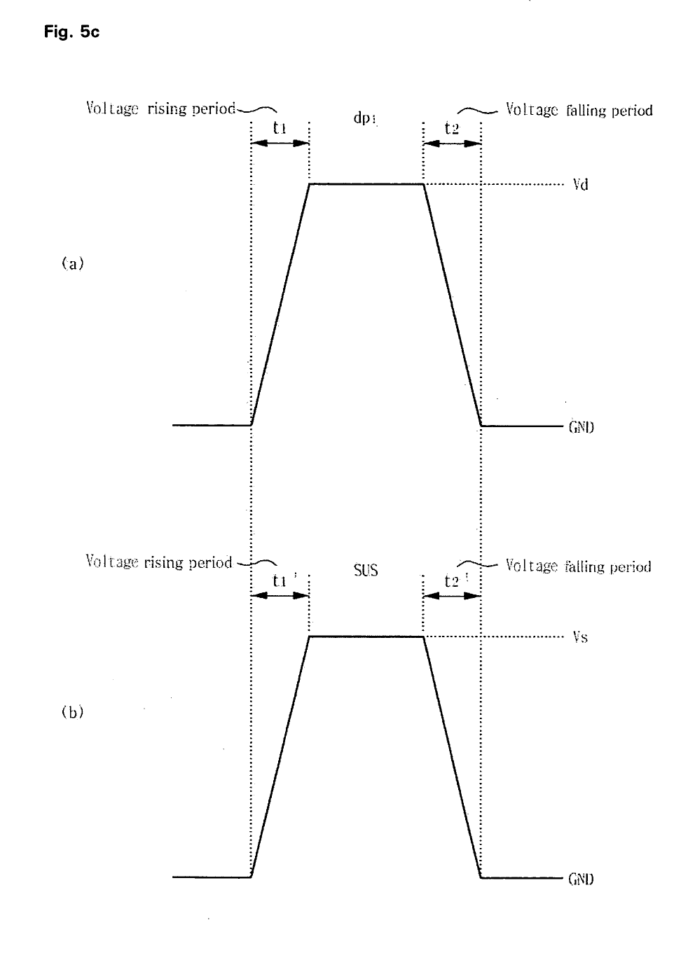

The operation of the driver 104, preferably, the data driver 101, for supplying a data pulse to the address electrodes X in synchronization with the scan pulse in the address period will be described in more detail with reference to FIG. 5.

FIGS. 5a to 5c are views for explaining in more detail the operation of the driver in the plasma display apparatus according to an embodiment of the present invention.

Firstly, as illustrated in FIG. 5, data pulses supplied to one address electrode X are shown. That is, data pulses supplied to a plurality of discharge cells located on one address electrode X are shown.

More concretely, the driver of reference numeral 104 in FIG. 1, more preferably, the data driver of reference numeral 101 supplies a plurality of data pulses to the address electrode X in the address period. Among the plurality of data pulses, the first data pulse is set different from the second data pulse.

That is, this may indicate that the voltage rising period and/or voltage falling period of the first data pulse is different from the voltage rising period and/or voltage falling period of the second data pulse.

Here, each of the first and second data pulses may be a plurality of data pulses. And, the first data pulse and the second data pulse may be applied in the same subfield.

More concretely through FIG. 5b, a voltage of the second data pulse dp1 supplied to discharge cells located on the Y1 scan electrode and Z1 sustain electrode as shown in FIG. 5a gradually rises from a ground level GND to a data voltage Vd during a voltage rising period t1 as shown in (a) of FIG. 5b, and at the time of falling, too, gradually falls from a data voltage Vd to a ground level GND during a voltage falling period t2. Here, it is preferred that the voltage rising period t1 of the second data pulse is substantially equal to the voltage falling period t2 of the second data pulse.

On the contrary, a voltage of the first data pulse sharply rises from a ground level GND to a data voltage Vd, and at the time of falling, too, sharply falls from a data voltage Vd to a ground level GND.

That is, if it is assumed that the second data pulse dp1 and the first data pulse dp2 are supplied to one address electrode X, the voltage rising period and/or voltage falling period of the second data pulse dp1 are more than the voltage rising period and/or voltage falling period of the first data pulse dp2.

If it is assumed that another first data pulse dp3 as shown in (c) is supplied after the supply of the first data pulse dp2, the voltage rising period and/or voltage falling period of the first data pulse dp2 and another first data pulse dp3 are more than the voltage rising period and/or voltage falling period of the second data pulse dp1.

Preferably, the voltage rising period and/or voltage falling period of the first data pulse dp2 as illustrated in (b) and another first data pulse dp3 as illustrated in (c) are approximately the same.

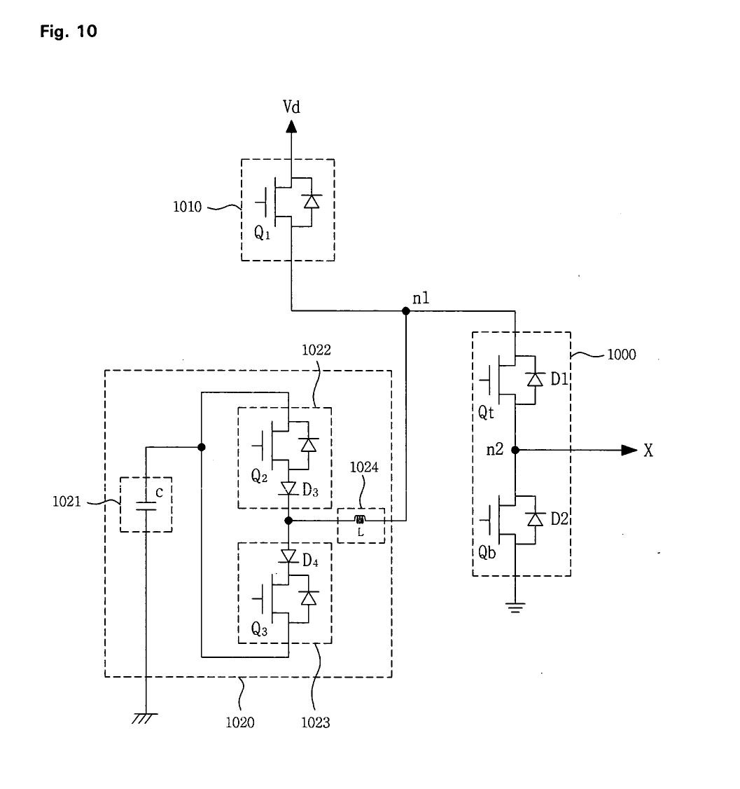

As above, the voltage rising period and/or voltage falling period of at least one (e.g., the second data pulse) of the plurality of data pulses supplied to the address electrode X is set different from the voltage rising period and/or voltage falling period of another data pulse (the first data pulse) is in order to prevent thermal/electrical damages of the driver by distributing heat generated over the switching devices of the driver for supplying data pulses, which will be discussed in more detail in the description of FIG. 10.

Here, the voltage rising period and/or voltage falling period of the second data pulse dp1 as illustrated in (b) are substantially equal to the voltage rising period and/or voltage falling period of a sustain pulse SUS supplied in the sustain period after the address period, which is shown in FIG. 5c.

Referring to FIG. 5c, (a) represents a second data pulse dp1 whose voltage rising period and/or voltage falling period are relatively long, and (b) represents a sustain pulse SUS which is supplied to the sustain electrodes in the sustain period.

Here, (voltage rising period, t1 of the second data pulse dp1 in (a) is substantially equal to the voltage rising period t1′ of the sustain pulse SUS, and the voltage falling period t2 of the second data pulse dp1 is substantially equal to the voltage falling period t2′ of the sustain pulse SUS.

As above, the voltage rising period and/or voltage falling period of the second data pulse dp1 are substantially equal to the voltage rising period and/or voltage falling period of the sustain pulse SUS because the same energy recovery circuit is used to a driving circuit for supplying the second data pulse dp1 and a driving circuit for supplying the sustain pulse SUS.

This will be discussed in more detail in the description of FIG. 10.

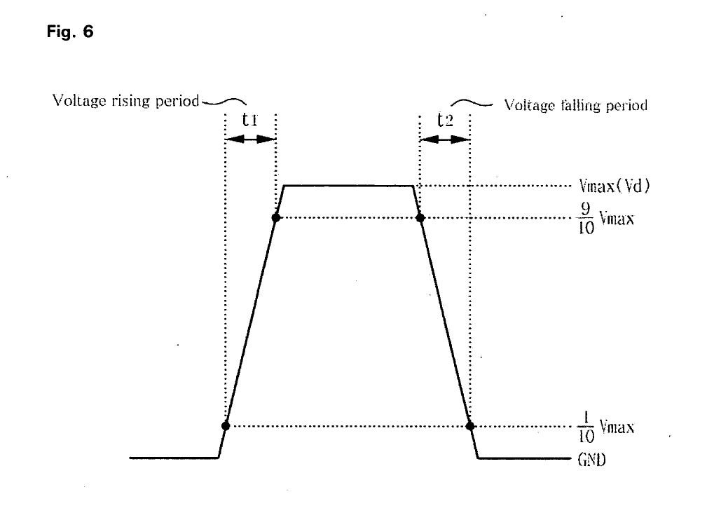

Meanwhile, the voltage rising period and voltage falling period of the aforementioned data pulse can be determined differently according to the magnitude of the maximum voltage of the data pulse, which will be described in more detail with reference to FIG. 6.

FIG. 6 is a view for explaining a method of determining the voltage rising period and falling period of a data pulse.

Referring to FIG. 6, preferably, the voltage rising period t1 of the second data pulse is the time taken for a voltage of the data pulse to rise from 10% of the maximum voltage Vmax to 90% of the maximum voltage Vmax.

For instance, if it is assumed that the maximum voltage of the data pulse, that is, the data voltage Vd, is 100V, the voltage rising period t1 of the second data pulse is the time taken for a voltage of the data pulse to rise from 10V to 90V.

Preferably, the voltage falling period t2 of the second data pulse is the time for a voltage of the data pulse to fall from 90% of the maximum voltage to 10% of the maximum voltage.

For instance, if it is assumed that the maximum voltage of the data pulse, that is, the data voltage Vd, is 100V, the voltage falling period t2 of the second data pulse is the time taken for a voltage of the data pulse to fall from 90V to 10V.

Meanwhile, in the above description, the case where the voltage rising period of at least one of the plurality of data pulses, e.g., the second data pulse as shown in FIG. 5a, is substantially equal to the voltage falling period thereof.

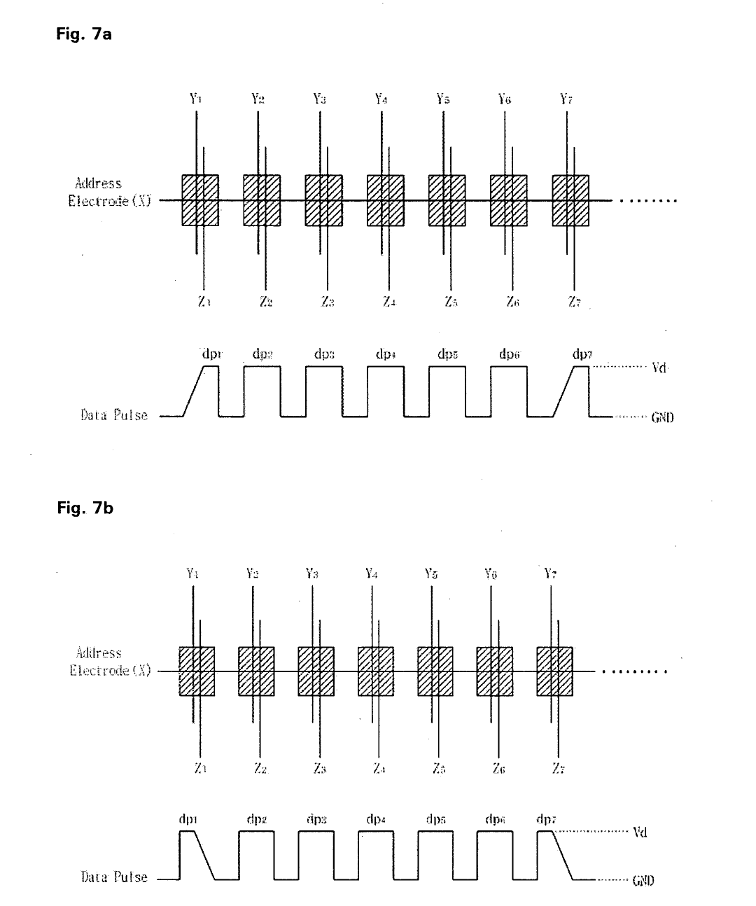

Alternately, the voltage falling period and voltage rising period of the second data pulse can be set differently, which will be discussed with reference to FIGS. 7a and 7b.

FIGS. 7a and 7b are views for explaining one example of a method of differentiating the voltage rising period and falling period of a data pulse.

Firstly, referring to FIG. 7a, in comparison with FIG. 5a, the voltage rising period of the second data pulse dp1 and another second data pulse dp7 are more than that of the first data pulse dp2 to dp6, and the voltage falling period of the second data pulse dp1 and another second data pulse dp7 are substantially equal to that of the first data pulse dp2 to dp6.

Alternately, as shown in FIG. 7b, in comparison with FIG. 5a, the voltage falling period of the second data pulse dp1 and another second data pulse dp7 can be set more than that of the first data pulse dp2 to dp6, and the voltage rising period of the second data pulse dp1 and another second data pulse dp7 can be set substantially equal to that of the first data pulse dp2 to dp6.

This can be accomplished in such a method that the driving circuit for supplying data pulses operates the energy recovery circuit only during either voltage rising period or voltage falling period to supply a data voltage Vd by a resonance of an inductor and directly supply a data voltage Vd during the other time. This will be discussed in more detail in the description of FIG. 10.

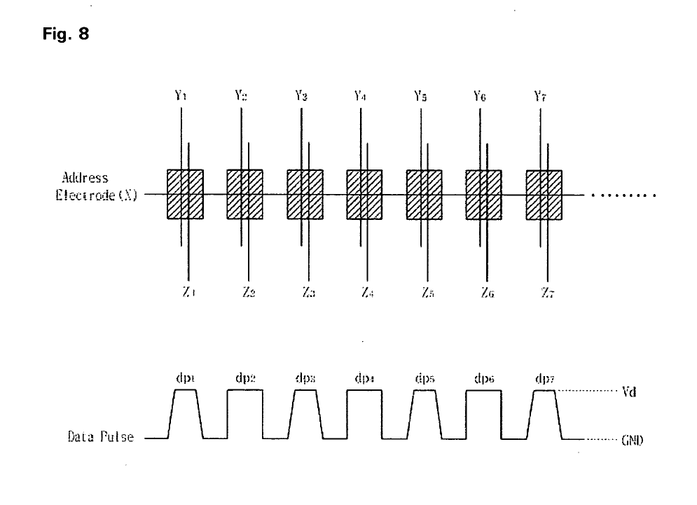

Another method for supplying a specific data pulse whose voltage rising period and/or voltage falling period are relatively more than those of another data pulse will be discussed with reference to FIG. 8.

FIG. 8 is a view for explaining another method for supplying a data pulse having a relatively long voltage rising period and/or falling period.

As illustrated in FIG. 8, the voltage rising period and/or voltage falling period of second data pulses dp1, dp3, dp5 and dp7 among the data pulses supplied to the address electrode X in the address period are more than the voltage rising period and/or voltage falling period of first data pulses dp2, dp4 and dp4. In other words, data pulses whose voltage rising period and/or voltage falling period are relatively long are supplied in an alternate way.

Although, in FIG. 8, data pulses whose voltage rising period and/or voltage falling period are relatively long are supplied in an alternate way, it is also possible to set the voltage rising period and/or voltage falling period of a half of the plurality of data pulses supplied to one address electrode X more than those of the other half of the data pulses.

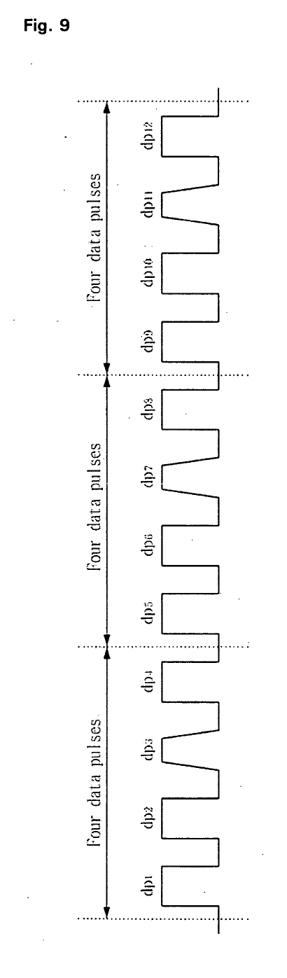

Meanwhile, unlike FIG. 8, the voltage rising period and/or voltage falling period of each one of a predetermined number of data pulses can be set more than those of the other data pulses, which will be discussed below with reference to FIG. 9.

FIG. 9 is a view for explaining yet another method for supplying a data pulse having a relatively long voltage rising period and/or falling period

As illustrated in FIG. 9, the voltage rising period and/or voltage falling period of each one of a predetermined number of data pulses among the plurality of data pulses supplied to the address electrode X can be set more than the voltage rising period and/or voltage falling period of the other data pulses.

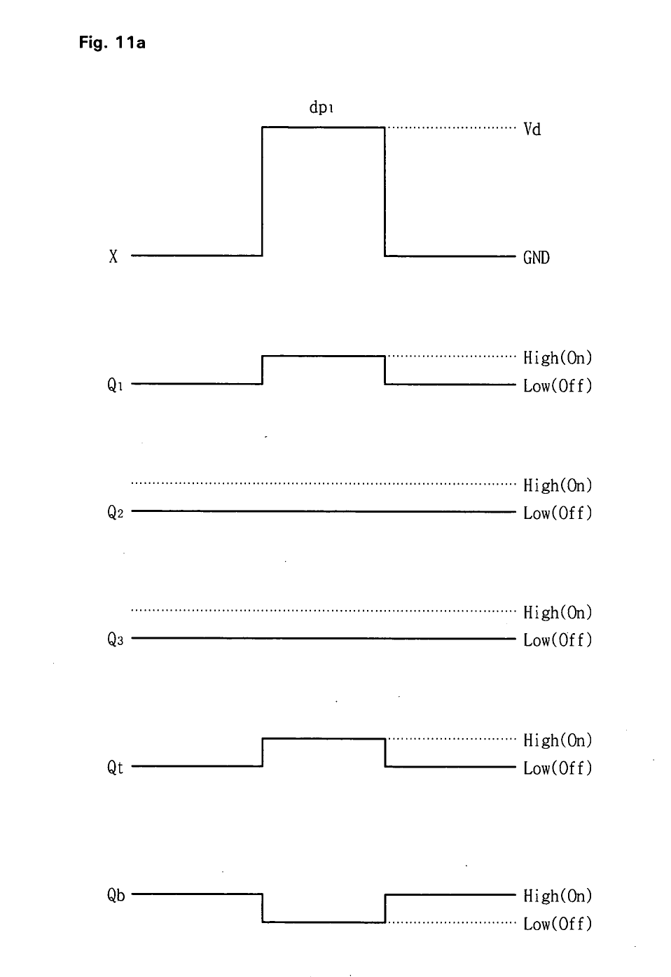

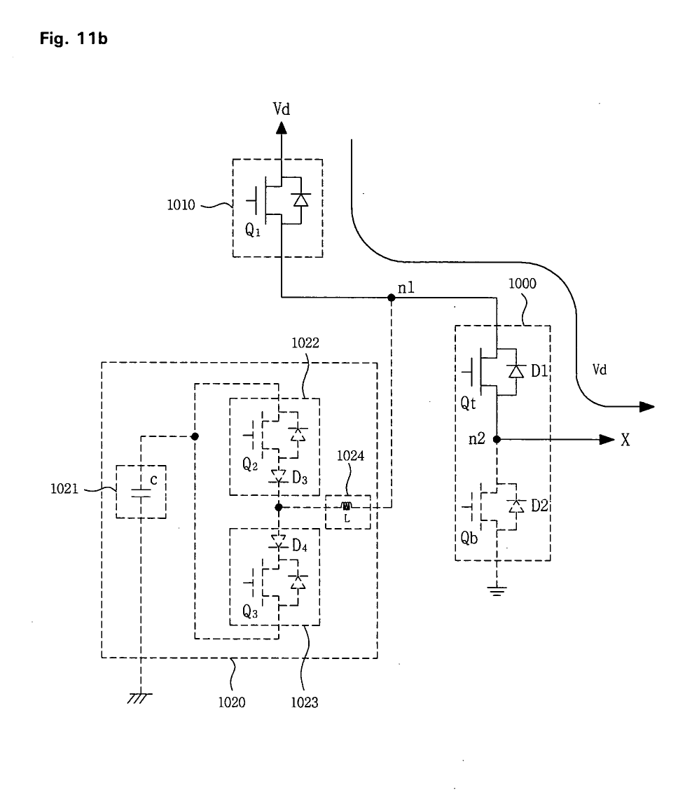

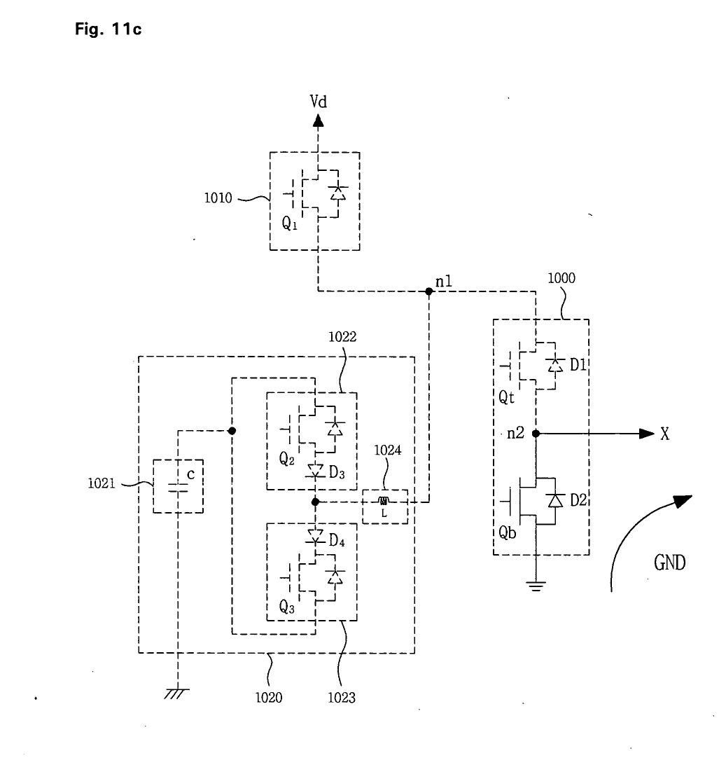

More preferably, the voltage rising period and/or voltage falling period of each one of four data pulses among the plurality of data pulses as shown in FIG. 11 are set more than the voltage rising period and/or voltage falling period of the other data pulses.

For instance, the voltage rising period and/or voltage falling period of the second data pulse dp3 of four data pulses dp1, dp2, dp3 and dp4 are set more than the voltage rising period and/or voltage falling period of the first data-pulses dp1, dp2 and dp4.

Further, the voltage rising period and/or voltage falling period of the second data pulse dp7 of the next four data pulses dp5, dp6, dp7 and dp8 are set more than the voltage rising period and/or voltage falling period of the first data pulses dp5, dp6 and dp8, and the voltage rising period- and/or voltage falling period of the second data pulse dp11 of the next subsequent data pulses dp9, dp10, dp11 and dp12 are set more than the voltage rising period and/or voltage falling period of the first data pulses dp9, dp10 and dp12.

As above, the voltage rising period and/or voltage falling period of each one of a predetermined number of data pulses are set more than the voltage rising period and/or voltage falling period of the other data pulses in order to distribute the heat generated in the driving circuit for supplying data pulses as uniformly as possible.

This will be discussed in more detail in the description of FIG. 10.

The construction and operation of the driver of FIG. 1, more preferably, of the data driver, for setting the voltage rising period and/or voltage falling period of one of the plurality of data pulses more than the voltage rising period and/or voltage falling period of the other data pulses will be described below.

FIG. 10 is a view for explaining the construction of the data driver of the plasma display apparatus according to an embodiment of the present invention.

As illustrated in FIG. 10, the driver, preferably, data driver of the plasma display apparatus according to an embodiment of the present invention comprises a data drive integrated circuit 1000, a data voltage supply controller 1010 and an energy recovery circuit 1020.

The data voltage supply controller 1010 comprises a data voltage supply control switch Q1, and supplies a data voltage Vd supplied from a data voltage source (not shown) to the data driver integrated circuit 1000.

The data driver integrated circuit 1000 is connected to address electrodes X of the plasma display panel, and supplies a voltage supplied to itself to the address electrodes X by a predetermined switching operation.

Preferably, the data driver integrated circuit 1000 is formed as a single module, separated from the data voltage supply controller 1010 and energy recovery circuit 1020. For instance, it is preferred that the data driver integrated circuit 1000 is formed in the form of a single chip on a TCP (tape carrier package).

In addition, it is preferred that the data driver integrated circuit 1000 comprises a top switch Qt and a bottom switch Qb.

Here, one end of the top switch is commonly connected to the data voltage supply controller 1010 and energy recovery circuit 1020, and the other end of the top switch is connected to one end of the bottom switch Qb.

The other end of the bottom switch Qb is grounded (GND), and a second node n2 between the other end of the top switch Q and one end of the bottom switch Qb is connected to the address electrodes X.

The energy recovery circuit 1020 comprises an energy storage unit 1021, an energy supply controller 1022, an energy recovery controller 1023 and an inductor 1024.

The energy storage unit 1021 comprises an energy storage capacitor C, stores energy to be supplied to the address electrodes X of the plasma display panel, and stores ineffective energy recovered from the plasma display panel.

The energy supply controller 1022 comprises an energy supply control switch Q2, and forms a supply path of the energy supplied to the address electrodes X of the plasma display panel from the energy storage capacitor C.

One end of such energy supply controller 1022 is connected to the energy storage capacitor C described above.

Preferably, the energy supply controller 1022 further comprises a reverse current preventing diode D3 for preventing a reverse current from flowing into the energy storage unit 1021 through the energy supply control switch Q2.

The energy recovery controller 1023 comprises an energy recovery control switch Q3, and forms a recovery path of the energy recovered to the energy storage capacitor C from the address electrodes X of the plasma display panel.

One end of such energy recovery controller 1023 is commonly connected to the energy storage capacitor C and energy supply controller 1022.

Preferably, the energy recovery controller 1023 further comprises a reverse current preventing diode D4 for preventing a reverse current from flowing into the energy recovery control switch Q3 from the energy storage unit 1021.

The inductor 1024 allows the energy stored in the energy storage unit 1021 to be supplied to the address electrodes X of the plasma display panel by a LC resonance, and allows ineffective energy of the plasma display panel to be recovered to the energy storage unit 1021 by a LC resonance.

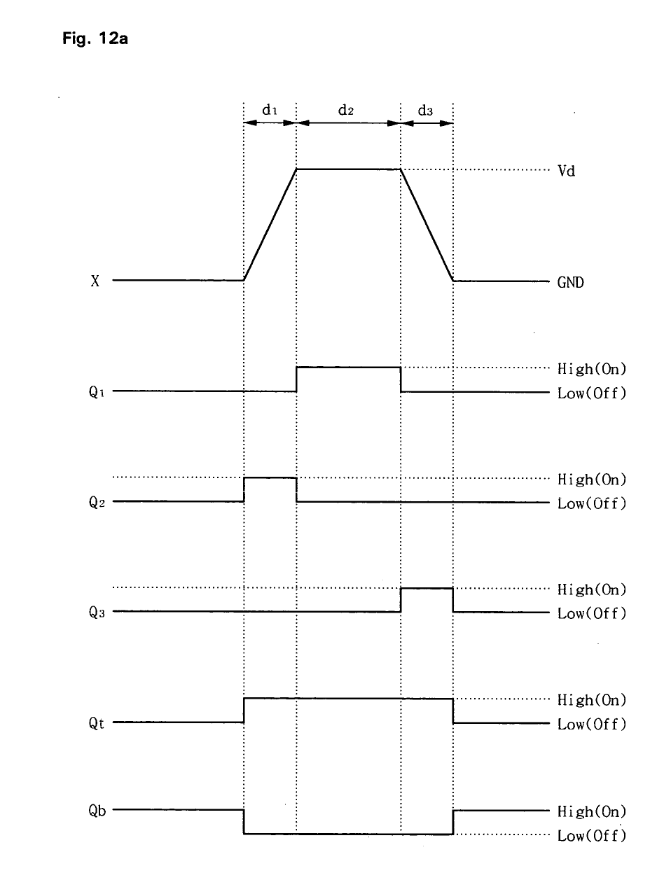

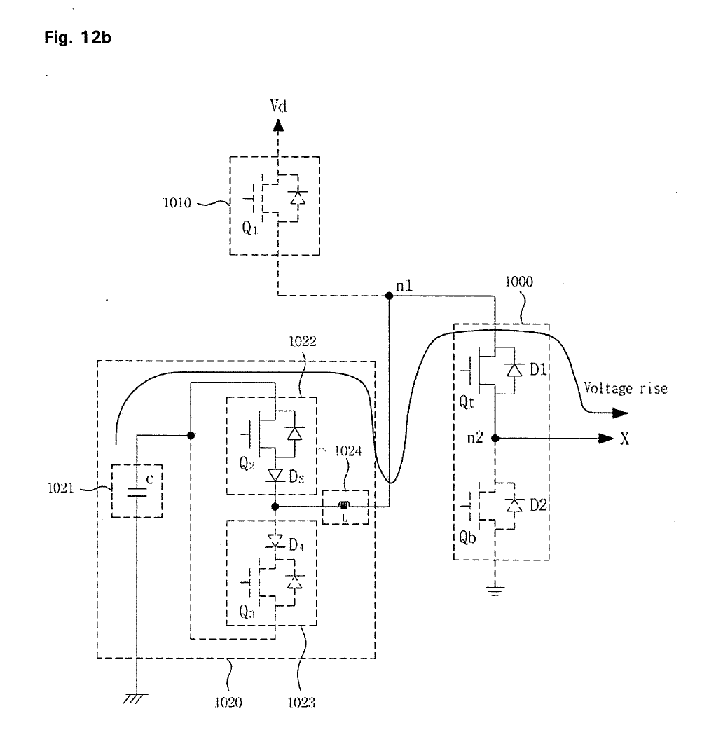

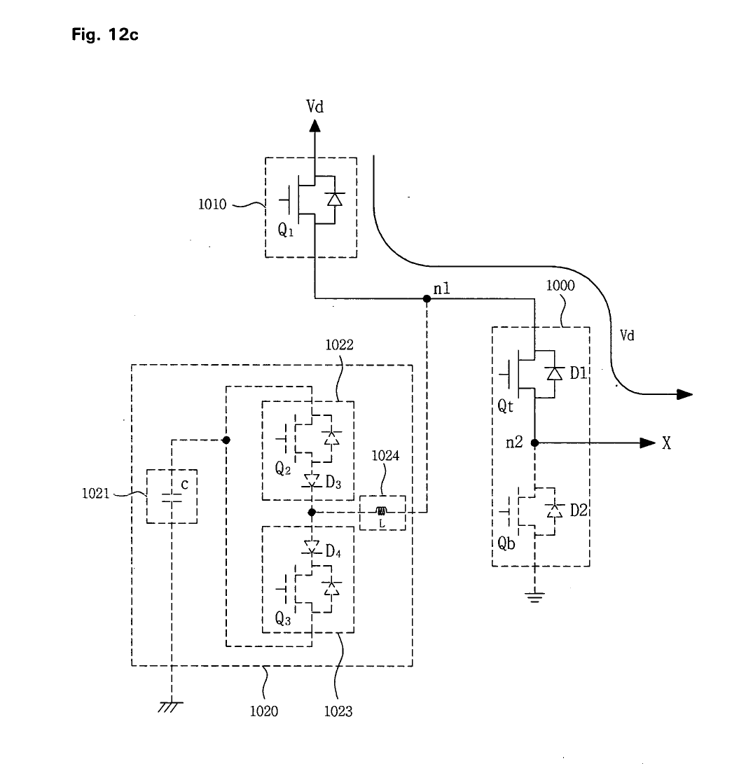

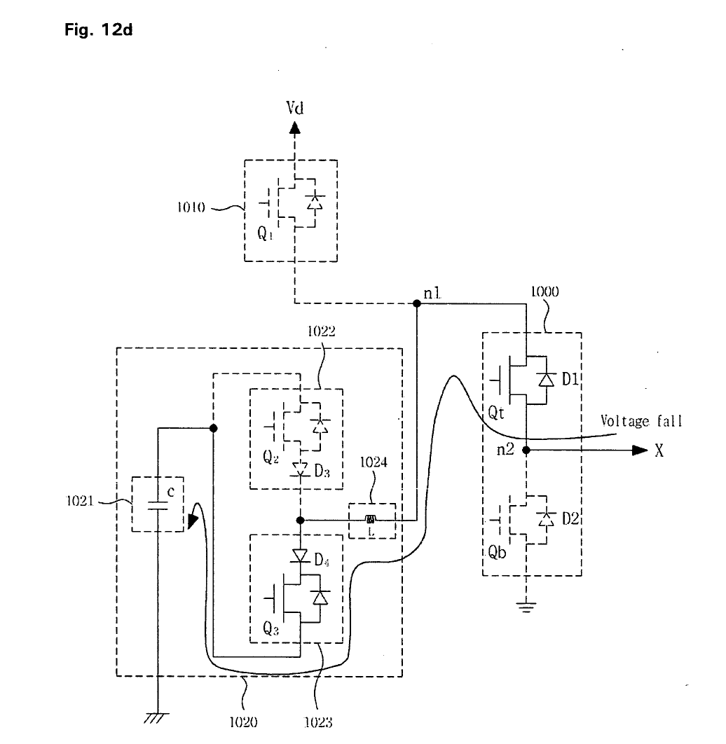

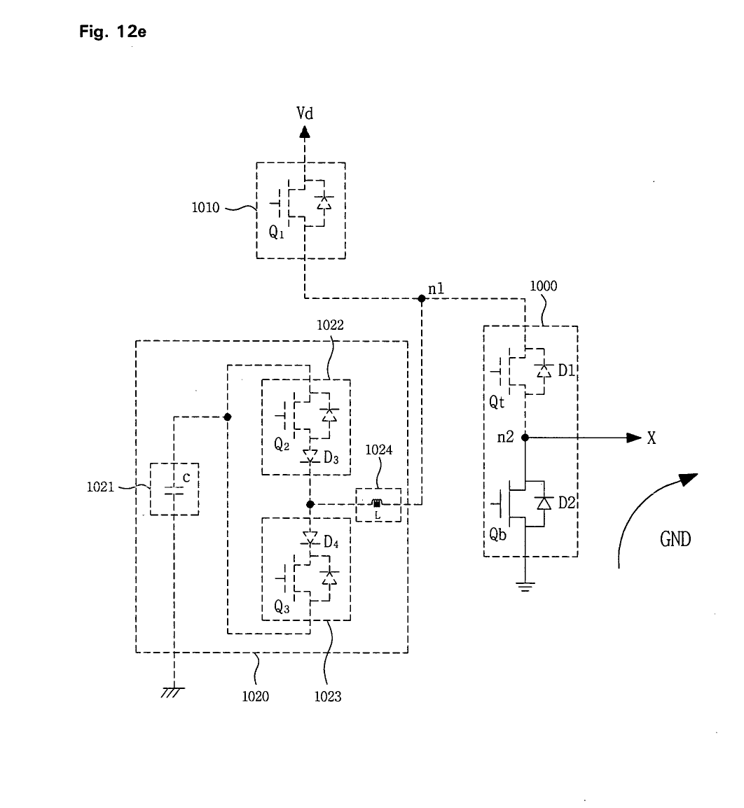

The operation of the driver of FIG. 10, preferably, of the data driver, will be discussed with reference to FIGS. 11a to 11c and FIGS. 12a to 12e.

FIGS. 11a to 11c are views for explaining the operation of the data driver of FIG. 10. FIGS. 12a to 12c are another views for explaining the operation of the data driver of FIG. 10.

Firstly, referring to FIG. 11a, there is shown a switching timing of the driver of FIG. 10, preferably, of the data driver, for generating a data pulse, e.g., a first data pulse dp1 as shown in FIG. 9, among a plurality of data pulses, whose voltage rising period and/or voltage falling period are relatively less than voltage rising period and/or voltage falling period of the other data pulses.

In a case where the first data pulse dp1 is supplied to the address electrodes X of the plasma display panel, the data voltage supply control switch Q1 of the data voltage supply controller 1010 and the top switch Qt of the data driver integrated circuit 1000 are turned on, and the energy supply control switch Q2 and energy recovery control switch Q3 of the energy recovery circuit 1020 and the bottom switch Qb of the data driver integrated circuit 1000 are turned off.

Then, as shown in FIG. 11b, a data voltage Vd is supplied to the address electrodes X of the plasma display panel through the top switch through a first node n1 by means of the data voltage supply control switch Q1 of the data voltage supply controller 1010.

After a data voltage Vd is supplied to the address electrodes X as shown in FIG. 11b, a voltage of the ground level GND is supplied to the address electrodes as shown in FIG. 11c.

As above, in the case where a voltage of the ground level GND is supplied to the address electrodes X of the plasma display panel after a data voltage Vd is supplied to the address electrodes X, the bottom switch Qb of the data driver integrated circuit 1000 is turned on, and the data voltage supply control switch Q1 of the data voltage supply controller 1010, the energy supply control switch Q2 and energy recovery control switch Q3 of the energy recovery circuit 1020 and the top switch Qt of the data driver integrated circuit 1000 are turned off.

Then, as shown in FIG. 11c, the voltage of the ground level GND is supplied to the address electrodes X of the plasma display panel through the bottom switch Qb of the data driver integrated circuit 1000.

Through the above procedure, a data pulse is supplied to the address electrodes X of the plasma display panel.

By a voltage difference between the scan pulse supplied to the scan electrodes Y in synchronization with the data pulse supplied to the address electrodes X, an address discharge is generated in the address period.

Next, referring to FIG. 12a, there is shown a switching timing of the driver of FIG. 10, preferably, of the data driver, for generating a data pulse, e.g., a second data pulse dp3 as shown in FIG. 9, among a plurality of data pulses, whose voltage rising period and/or voltage falling period are relatively less than voltage rising period and/or voltage falling period of second data pulses dp1, dp2 and dp4.

In the period d1 in which the second data pulse dp3 is supplied to the address electrodes X of the plasma display panel, firstly, as shown in FIG. 12b, the energy supply control switch Q2 of the energy supply controller 1022 of the energy recovery circuit 1020 is turned on, and the top switch Qt of the data driver integrated circuit 1000 is turned on, too.

The energy recovery control switch Q3 of the energy recovery circuit 1020, the data voltage supply control switch Q1 of the data voltage supply controller 1010 and the bottom switch Qb of the data driver integrated circuit are turned off.

Then, as shown in FIG. 12b, the energy stored in the energy storage capacitor C of the energy storage unit 1021 is supplied to the address electrodes X of the plasma display panel through the energy supply controller 1022, the inductor 1024 and the top switch Qt of the data driver integrated circuit 1000.

At this time, as a LC resonance is generated in the inductor 1024, a voltage of the energy supplied to the address electrodes X of the plasma display panel gradually rises with a predetermined slope as in the period d1. That is, a gradually rising voltage is supplied to the address electrodes X.

After a data voltage Vd is supplied to the address electrodes X as in the period d1, a data voltage Vd is supplied to the address electrodes X as in the period d2.

As above, in the case where a data voltage Vd is supplied to the address electrodes X, the data voltage supply control switch Q1 of the data voltage supply controller 1010 and the top switch Qt of the data driver integrated circuit 1000 are turned on, and the energy supply control switch Q2 and energy recovery control switch Q3 of the energy recovery circuit 1020 and the bottom switch Qb of the data driver integrated circuit 1000 are turned off.

Then, as shown in FIG. 2c, the data voltage Vd is supplied to the address electrodes X of the plasma display panel through the top switch Qt of the data driver integrated circuit 1000 through the first node n1 by means of the data voltage supply control switch Q1 of the data voltage supply controller 1010.

After the data voltage Vd is supplied to the address electrodes X as in the period d2, a gradually falling voltage is supplied to the address electrodes X as in the period d3.

In the period d3 in which a gradually falling voltage is supplied to the address electrodes X of the plasma display panel, as shown in FIG. 12d, the energy recovery control switch Q3 of the energy recovery controller 1023 of the energy recovery circuit 1020 is turned on, and the top switch qt of the data driver integrated circuit 1000 is turned on, too.

The energy supply control switch Q2 of the energy recovery circuit 1020, the data voltage supply control switch Q1 of the data voltage supply controller 1010 and the bottom switch Qb of the data driver integrated circuit are turned off.

Then, as shown in FIG. 12d, ineffective energy of the plasma display panel is recovered to the energy storage capacitor C of the energy storage unit 1221 through the top switch Qt of the data driver integrated circuit 1000, the inductor 1024 and the energy recovery controller 1023.

At this time, as a LC resonance is generated in the inductor 1024, a voltage of the energy recovered from the address electrodes X of the plasma display panel gradually falls with a predetermined slope as in the period d3.

After the data voltage Vd is supplied to the address electrodes X as in FIG. 12d, a voltage of the ground level GND is supplied to the address electrodes X as shown in FIG. 12e.

As above, in the case where a voltage of the ground level GND is supplied to the address electrodes X, the bottom switch Qb of the data driver integrated circuit 1000 is turned on, and the data voltage supply control switch Q1 of the data voltage supply controller 1010, the energy supply control switch Q2 and energy recovery control switch Q3 of the energy recovery circuit 1020 and the top switch Qt of the data driver integrated circuit 1000 are turned off.

Then, as shown in FIG. 12e, the voltage of the ground level GND is supplied to the address electrodes X of the plasma display panel through the bottom switch Qb of the data driver integrated circuit 1000.

Through the above procedure, a data pulse whose voltage rising period and/or voltage falling period are relatively long is supplied to the address electrodes X of the plasma display panel.

By a voltage difference between the scan pulse supplied to the scan electrodes Y in synchronization with the data pulse supplied to the address electrodes X, an address discharge is generated in the address period.

In the plasma display apparatus thus-operated according to an embodiment of the present invention, it does not matter even if the switching devices used in the data driver integrated circuit as illustrated in FIG. 10, that is, the top switch Qt and the bottom switch Qb, are relatively low in withstand voltage as compared to the conventional art.

For instance, when a data pulse is supplied to the address electrodes X as in FIGS. 11a to 11c, the magnitude of the current flowing in the top switch Qt of the data driver integrated circuit of reference numeral 1000 and the magnitude of the power consumed in the top switch Qt are substantially equal to in the above-said mathematical formula 1.

That is, if it is assumed that the magnitude of the data voltage Vd is 60V, it can be seen that the top switch Qt of the data driver integrated circuit of reference numeral 100 as in FIGS. 11a to 11c consumes a power of i×60V upon driving.

At this time, the top switch Qt generates heat in proportion to a power consumption W.

For example, if it is assumed that the resistance of the top switch Qt and the resistance of the data voltage supply control switch Q1 are 30Ω (Ohm), the top switch Qt generates heat of (60/30)×60=120 W.

Unlike in FIGS. 11a to 11c, when a data pulse whose voltage rising period and/or voltage falling period are relatively long is supplied to the address electrodes X as in FIGS. 12a to 12e, the magnitude of the current flowing in the top switch Qt of the data driver integrated circuit of reference numeral 1000 and the magnitude of the power consumed in the top switch Qt will be explained as follows.

When a data pulse whose voltage rising period and/or voltage falling period are relatively long is supplied to the address electrodes X as in FIGS. 12a to 12e, the energy stored in the energy storage unit of reference numeral 1021 is supplied to the top switch Qt of the data driver integrated circuit 1000 by a resonance of the inductor of reference numeral 1024.

Hence, when a data pulse, such as the second data pulse dp3 of FIG. 9, whose voltage rising period and/or falling period are relatively long, is supplied, most of the heat generated in the driver, preferably, the data driver, is concentrated on the energy recovery circuit 1021, while only a small amount of heat is generated in the data driver integrated circuit 1000.

More concretely, in the period d1 of FIG. 12a, the energy stored in the energy storage unit of reference numeral 1021 is supplied to the top switch Qt of the data driver integrated circuit 1000 by a resonance of the inductor of reference numeral 1024. Thus, most of the heat is generated in the energy supply control switch Q2 of the energy supply controller of reference numeral 1022 and in the inductor 1024. Accordingly, the amount of heat generated in the top switch Qt is very little.

Next, in the period d2 of FIG. 12a, a difference between the voltage supplied to the top switch Qt by the energy recovery circuit 1020 by a resonance and the voltage supplied to the top switch Qt through the data voltage supply controller 1010 is relatively very small, so a voltage variation substantially sensed by the top switch Qt is very small.

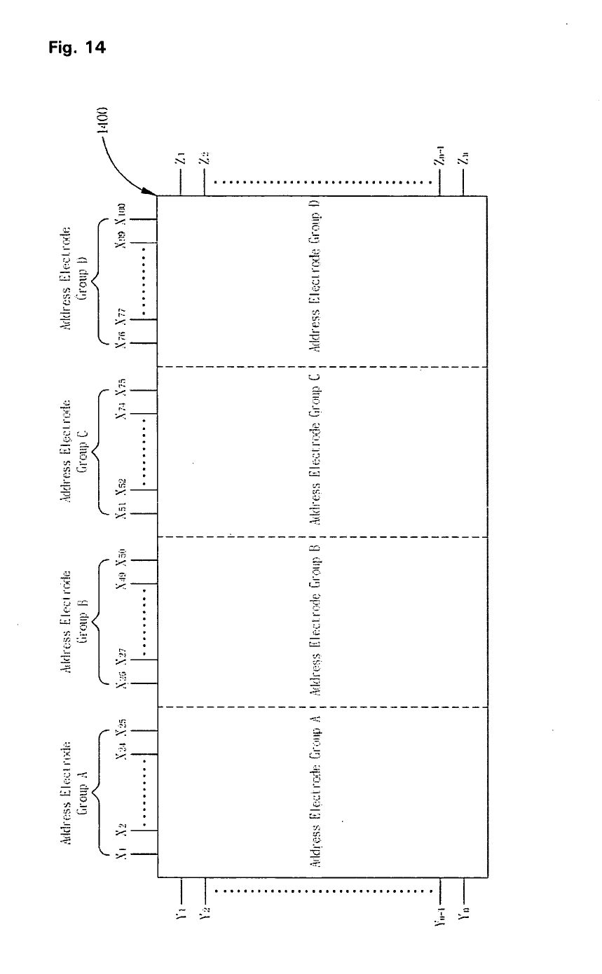

Accordingly, the amount of current flowing in the top switch Qt in the period d2 of FIG. 14a becomes so small, and as a result, the amount of heat generated in the top switch Qt becomes so little.

Next, in the period d3 of FIG. 12a, ineffective energy of the plasma display panel is recovered to the energy storage unit of reference numeral 1021 by a resonance of the inductor of reference numeral 1024, and supplied to the top switch Qt of the data driver integrated circuit 1000. Thus, most of the heat is generated in the energy recovery control switch Q3 of the energy recovery controller of reference numeral 1023 and in the inductor 1024. Accordingly, the amount of heat generated in the top switch Qt is very little.

Putting the above explanations together, it can be seen that the when a data pulse as in FIG. 9 is supplied to the address electrodes X of the plasma display panel, heat generated in the driver, preferably, data driver, is not concentrated on a certain specific region but distributed.

For instance, when the first data pulse dp1 of FIG. 9 is supplied, a certain amount of heat is generated in the top switch Qt of the data driver integrated circuit of reference numeral 1000 through the procedure as in the above-said mathematical formula 1.

On the contrary, when the second data pulse dp3 of FIG. 9 is supplied, most of the heat is generated in the energy recovery circuit of reference numeral 1020, and only a small amount of heat is generated in the top switch Qt of the data driver integrated circuit of reference numeral 1000.

Accordingly, in the case where a data pulse of the pattern as in FIG. 11 is supplied, the heat generated in the top switch Qt of the data driver integrated circuit of reference numeral 1000 is reduced by approximately 25% as compared to the conventional art.

In other words, the heat generated in the driver, preferably, data driver, of the plasma display apparatus according to an embodiment of the present invention is distributed over the data driver integrated circuit 1000, the energy recovery circuit 1020 and the data voltage supply controller 1010.

Accordingly, it becomes possible to prevent thermal damage of a switching device included in the data driver, for example, the top switch Qt included in the data driver integrated circuit 1000, upon driving the driver, preferably, data driver of the plasma display apparatus according to an embodiment of the present invention.

Needless to say, this is not limited to the top switch Qt but also applicable to the bottom switch Qb.

Unlike the above detailed description, it is also possible to divide the plurality of address electrodes X included in one plasma display panel into a plurality of address electrode groups and adjusting the voltage falling period and/or voltage rising period of data pulses in the divided address electrode groups, which will be discussed below.

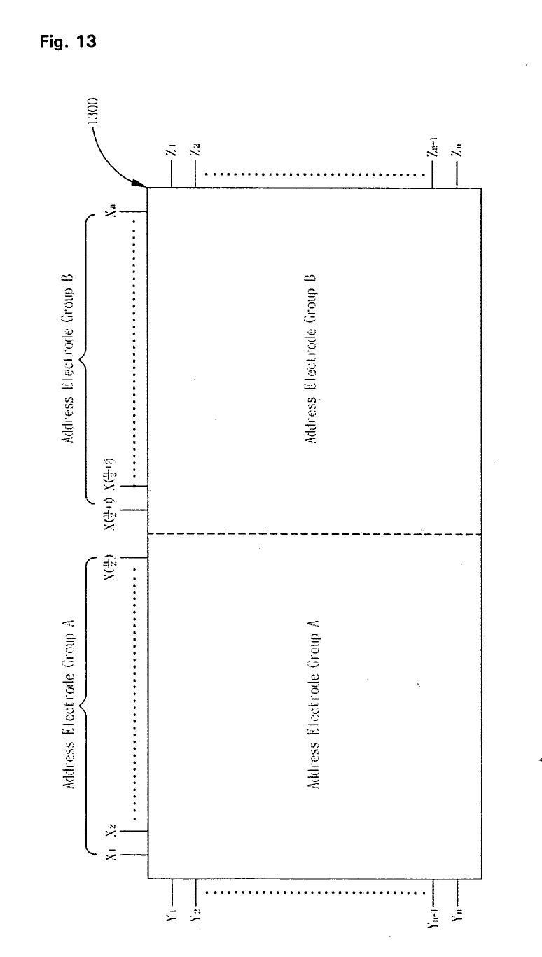

FIG. 13 is a view for explaining one example of a method for dividing a plurality of address electrodes formed on the plasma display panel into two address electrode groups.

As illustrated in FIG. 13, the address electrodes X on the plasma display panel 1300 are divided into an address electrode group A and an address electrode group B.

For instance, if the total number of address electrodes formed on a single plasma display panel is m, the address electrode group A includes first to (m)/2-th address electrodes, and the address electrode group B includes (m/2)+1-th to m-th address electrodes.

The number of the address electrode groups is set to two because it is advantageous to divide the plasma display panel into two regions, e.g., left and right parts, for driving in terms of manufacturing costs of driving boards.

Meanwhile, although in FIG. 13, the plurality of address electrodes formed on a single plasma display panel are divided into two address electrode groups, the number of the address electrode groups can be set different from FIG. 13, which will be discussed with reference to FIG. 14.

FIG. 14 is a view showing one example of a method for dividing the address electrodes formed on the plasma display panel into four address electrode groups.

As illustrated in FIG. 14, the address electrodes X on the plasma display panel 1600 are divided into an address electrode group A, an address electrode group B, an address electrode group C and an address electrode group D.

For instance, if the total number of address electrodes formed on a single plasma display panel 1400 is 100, the address electrode group A includes first to 25-th address electrodes X1 to X25, and the address electrode group B includes 26-th to 50-th address electrodes X26 to X50.

In this manner, the address electrode group C includes 51-th to 75-th address electrodes X51 to X75, and the address electrode group D includes 76-th to 100-th electrodes X76 to X100.

Here, the number of address electrode groups ranges from a minimum of two to a maximum of the total number of address electrodes, that is, the number of address electrode groups can be set under the condition of 2≦N≦(m−1) if the total number of address electrodes is denoted by m and the number of address electrode groups is denoted by N.

Meanwhile, although in FIG. 14, the number of address electrodes included in each of the address electrode groups A, B, C and D is set equal to each other, it may be also possible to set the number of address electrodes X included in at least one of the plurality of address electrode groups different that that of the other address electrode groups.

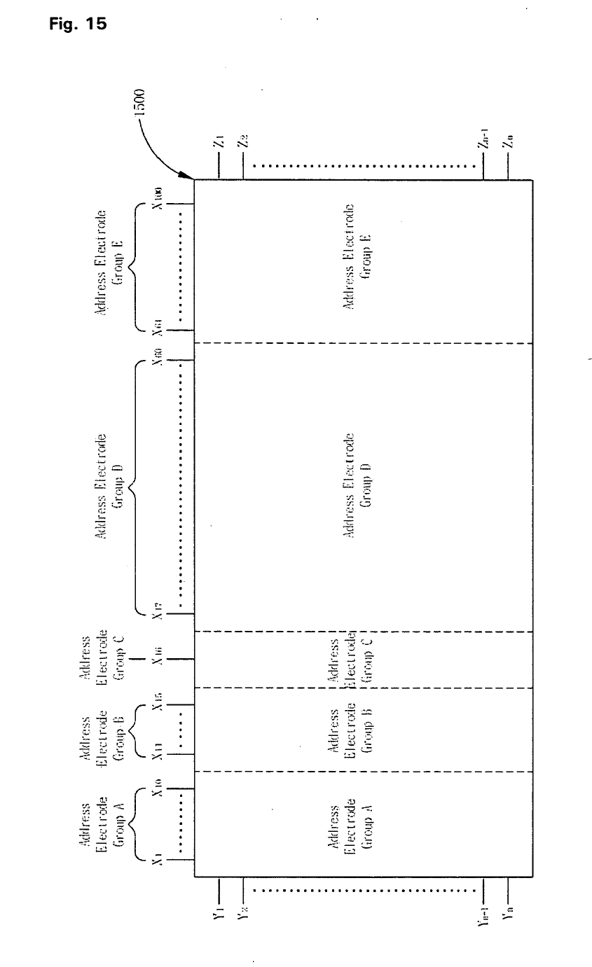

Further, the number of address electrode groups, too, can be adjusted. An example of setting the number of address electrodes X included in the address electrode groups different and adjusting the number of address electrode groups will be discussed with reference to FIG. 15.

FIG. 15 is a view for explaining one example of dividing the address electrodes X formed on the plasma display panel into one or more address electrode groups, each comprising a different number of address electrodes X.

As illustrated in FIG. 15, the plurality of address electrodes on the plasma display panel 1500 are divided into an address electrode group A, an address electrode group B, an address electrode group C, an address electrode group D and an address electrode group E.

For instance, as shown in FIG. 14, if it is assumed that the total number of address electrodes formed on a single plasma display panel is 100, the address electrode group A includes first to 10-th address electrodes X1 to X10, and the address electrode group B includes 11-th to 15-th address electrodes X11 to X15.

Further, the address electrode group C includes a 16-th address electrode X16, the address electrode group D includes 17-th to 60-th address electrodes X17 to X60, and the address electrode group E includes 61-th to 100-th address electrodes X61 to X100.

As above, the number of address electrodes X included in one or more of the address electrode groups is different from that of the other address electrode groups. In FIG. 15, the number of address electrodes X included in each of the address electrode groups A, B, C, D and E is all different.

Further, the aforementioned address electrode group C is an address electrode group including only one address electrode, that is, the 16-th address electrode X16, in which a single address electrode X constitutes a single address electrode group unlike the other address electrode groups.

In FIG. 15, each of the address electrode groups includes a different number of address electrodes X. However, unlike this, only a predetermined address electrode group selected from the plurality of address electrode groups may include a different number of address electrodes X than the other address electrode groups.

For instance, the address electrode group A may include 10 address electrodes, the address electrode group B may include another 10 address electrodes, and the subsequent address electrode group C, address electrode group D, address electrode group E and address electrode group F may include 20 address electrodes, respectively.

The operation of the plasma display apparatus in which the address electrodes X on the plasma display panel are divided into a plurality of address electrode groups, for example, two address electrode groups as in FIG. 13, for driving will be described below.

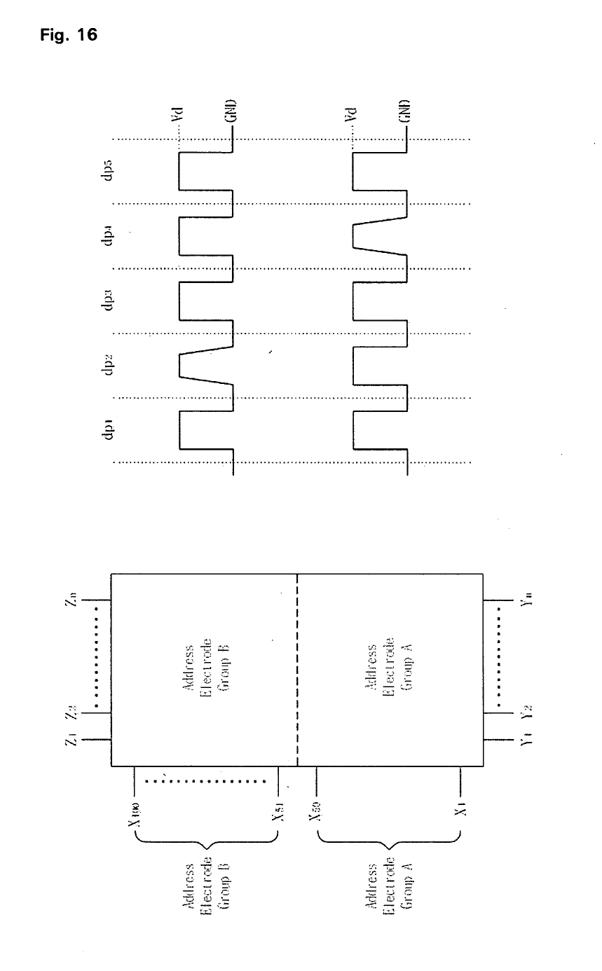

FIG. 16 is a view for explaining the operation of the plasma display apparatus according to an embodiment of the present invention in a case that the plurality of address electrodes X is divided into two address electrode groups.

As illustrated in FIG. 16, there is shown a data pulse supplied to each of address electrode groups, in a case where the plurality of address electrodes X are divided into two address electrode groups, for example, an address electrode group A and an address electrode group B as in FIG. 13.

The feature of the present invention to be described in FIG. 16 is that the voltage falling period and/or voltage rising period of a N-th (N is a natural number) data pulse among the data pulses supplied to at least one of the plurality of address electrodes including one or more address electrodes X are different from the voltage falling period and/or voltage rising period of a N-th data pulse among the data pulses supplied to the other address electrode groups.

For instance, a plurality of data pulses dp1 to dp5 are sequentially supplied to the address electrode group A including first to 50-th address electrodes X1 to X50. At this time, the voltage rising period and/or voltage falling period of the second data pulse dp4 are relatively more than the voltage rising period and/or voltage falling period of the first data pulses dp1, dp2, dp3 and dp5.

Further, a plurality of data pulses dp1 to dp5 are sequentially supplied to the address electrode group B including 51-th to 100-th address electrodes X51 to X100. At this time, the voltage rising period and/or voltage falling period of the second data pulse dp2 are relatively more than the voltage rising period and/or voltage falling period of the other data pulses, that is, the first data pulses dp1, dp3, dp4 and dp5.

Viewed from another aspect, the voltage rising period and/or voltage falling period of the second leading data pulse among the data pulses supplied to the address electrode group B, that is, of the second data pulse dp2, are different from the voltage rising period and/or voltage falling period of the first data pulse dp2 which is the second leading data pulse among the data pulses supplied to the address electrode group A.

Further, the voltage rising period and/or voltage falling period of the fourth leading data pulse among the data pulses supplied to the address electrode group A, that is, of the first data pulse dp4, are different from the voltage rising period and/or voltage falling period of the fourth leading data pulse among the data pulses supplied to the address electrode group B, that is, of the second data pulse dp4.

By adjusting the voltage rising period and/or voltage falling period of the data pulses supplied to at least one address electrode group, as already described in detail, thermal damage of each driver, preferably, data driver, for supplying data pulses to each of the address electrode groups can be prevented, and noise generated upon supplying data pulses is reduced.

If it is assumed that the voltage rising period and voltage falling period of the data pulses supplied to the address electrode group A and of the data pulses supplied to the address electrode group B are the same, a voltage of the data pulses supplied to the address electrode group B rises to the same extent as a voltage of the data pulses supplied to the address electrode group A when the voltage of the data pulses supplied to the address electrode group A rises.

Accordingly, noise is generated by a coupling effect between the data pulses supplied to the address electrode group A and the data pulses supplied to the address electrode group B. This is also applied when the voltage of the data pulses falls.

To solve the problem of noise, in FIG. 16, the first data pulse dp2, whose voltage rising period and/or voltage falling period are relatively less than the second data pulse dp2 supplied to the address electrode group B, is supplied to the address electrode group A when the second data pulse dp2 is supplied to the address electrode group B.

Then, as the coupling effect between the second data pulse dp2 supplied to the address electrode group A and the first data pulse dp2 supplied to the address electrode group B becomes relatively weak, the noise generated upon supplying data pulses is reduced.

On the contrary, it is preferred that the voltage falling period and/or voltage rising period of a N-th (N is a natural number) data pulse among the data pulses supplied to all of the address electrodes X included in the same address electrode group are equal.

For instance, data pulses of the same pattern as the pattern supplied to the address electrode group A are supplied all of the address electrodes X included in the address electrode group, that is, the first address electrode X1 to the 50-th address electrode X50.

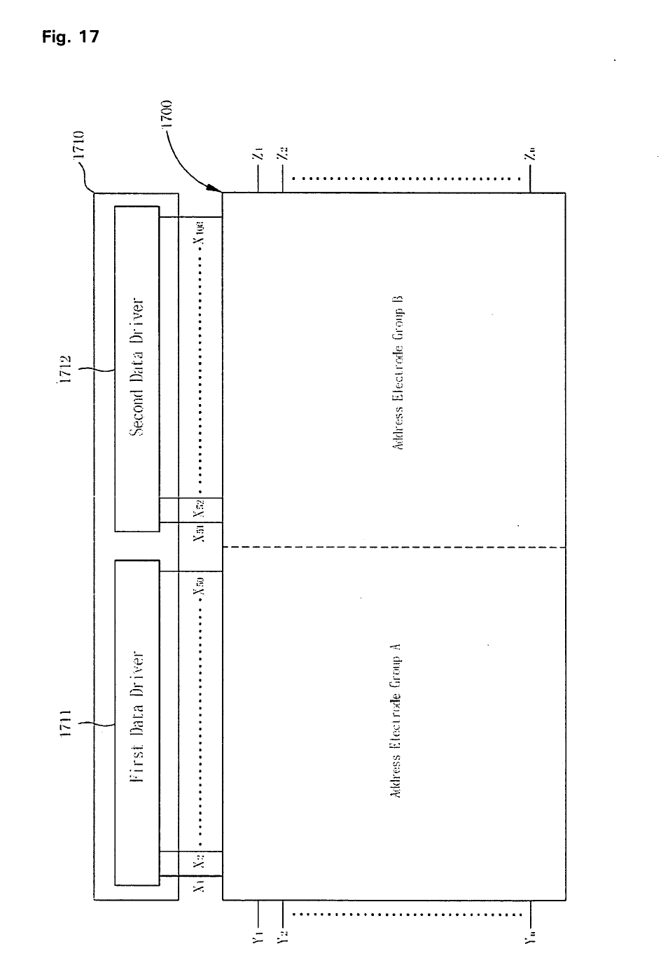

As above, in FIG. 16, in order to supply data pulses of different patterns to two different address electrode groups, it is preferred that two different drivers, preferably, data drivers, supply different data pulses to each of the address electrode groups. This will be discussed with reference to FIG. 17.

FIG. 17 is a view for explaining the construction of the driver for supplying data pulses of different patterns to two address electrode groups.

As illustrated in FIG. 17, in a case where the plurality of address electrodes X formed on the plasma display panel 1700 are divided into two address electrode groups, for example, an address electrode group A and an address electrode group B, the driver 1710 of the plasma display apparatus according to an embodiment of the present invention comprises a first data driver 1711 for supplying data pulses to the address electrode group A and a second data driver 1712 for supplying data pulses to the address electrode group B.

The first and second data drivers 1711 and 1712 supply data pulses of different patterns to the address electrode group A and the address electrode group B.

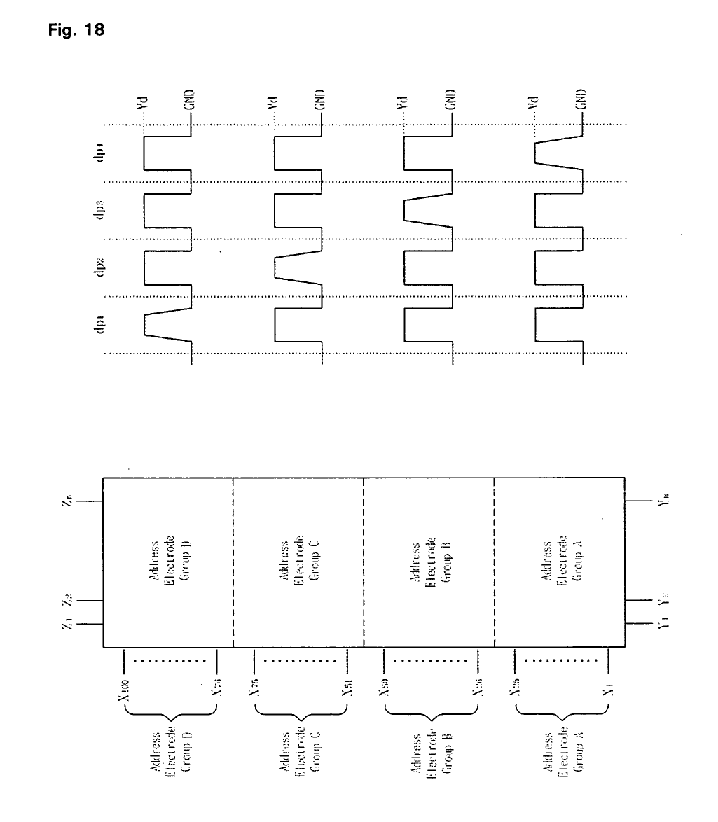

As above, the first data driver 1711 supplies the same pattern as the data pulses supplied to the address electrode group A in FIG. 18, and the second data driver 1712 supplies the same pattern as the data pulses supplied to the address electrode group B in FIG. 18, thereby preventing the first data driver 1711 from getting thermal/electrical damages as already described in detail.

Furthermore, the first data driver 1711 is prevented from getting thermal/electrical damages.

Although FIGS. 16 to 18 illustrate only an example in which the plurality of address electrodes X formed on the plasma display panel are divided into two address electrode groups, the plurality of address electrodes X formed on the plasma display panel may be divided into three or more address electrode groups to supply data pulses. This will be discussed below.

FIG. 18 is a view for explaining the operation of the plasma display apparatus according to an embodiment of the present invention in a case that the plurality of address electrodes X is divided into three or more address electrode groups.

As illustrated in FIG. 18, there are shown data pulses supplied to each of the address electrode groups in a case where the plurality of address electrodes X are divided into three or more address electrode groups (FIG. 18 illustrates and describes only a case of dividing into four address electrode groups), for example, an address electrode group A, an address electrode group B, an address electrode group C and an address electrode group D as in FIG. 14.

More concretely, as in FIG. 16, the voltage falling period and/or voltage rising period of a N-th (N is a natural number) data pulse among the data pulses supplied to at least one of the plurality of address electrodes including one or more address electrodes X are different from the voltage falling period and/or voltage rising period of a N-th data pulse among the data pulses supplied to the other address electrode groups.

Still more concretely, if the number of address electrode groups is M (M is a natural number of two or more), the voltage falling period and/or rising period of the N-th (N is a natural number) data pulse among the data pulses supplied to one of the M number of address electrode groups is different from the voltage falling period and/or rising period of the N-th data pulse among the data pulses supplied to the other M−1 number of address electrode groups.

Moreover, the voltage falling period and/or rising period of the N-th data pulse among the data pulses supplied to the other M−1 number of address electrode groups are equal in all of the address electrode groups.

For instance, a plurality of data pulses dp1 to dp4 are sequentially supplied to the address electrode group A including first to 25-th address electrodes X1 to X25. At this time, the voltage rising period and/or voltage falling period of the second data pulse dp4 are relatively more than those of the other data pulses, that is, the first data pulses dp1, dp2 and dp3.

Further, a plurality of data pulses dp1 to dp4 are sequentially supplied to the address electrode group B including 26-th to 50-th address electrodes X26 to X50. At this time, the voltage rising period and/or voltage falling period of the second data pulse dp3 are relatively more than the voltage rising period and/or voltage falling period of the other data pulses, that is, the first data pulses dp1, dp2 and dp4.

Further, a plurality of data pulses dp1 to dp4 are sequentially supplied to the address electrode group C including 51-th to 75-th address electrodes X51 to X75. At this time, the voltage rising period and/or voltage falling period of the second data pulse dp2 are relatively more than the voltage rising period and/or voltage falling period of the other data pulses, that is, the first data pulses dp1, dp3 and dp4.

Further, a plurality of data pulses dp1 to dp4 are sequentially supplied to the address electrode group D including 75-th to 100-th address electrodes X75 to X100. At this time, the voltage rising period and/or voltage falling period of the second data pulse dp1 are relatively more than the voltage rising period and/or voltage falling period of the other data pulses, that is, the first data pulses dp2, dp3 and dp4.

Viewed from another aspect, the voltage rising period and/or voltage falling period of the leading data pulse among the data pulses supplied to the address electrode group D (first address electrode group), that is, of the second data pulse dp1, are different from the voltage rising period and/or voltage falling period of the first data pulses dp1 which are the leading data pulse among the data pulses supplied to the address electrode groups A, B and C (second address electrode groups).

Moreover, the voltage rising period and/or voltage falling period of the first data pulses dp1, which are the leading data pulse among the data pulses supplied to the address electrode groups A, B and C (second address electrode groups), are approximately the same.

Additionally, the voltage rising period and/or voltage falling period of the second data pulse dp2, which is the second leading data pulse among the data pulses supplied to the address electrode group C (first address electrode group), are different from the voltage rising period and/or voltage falling period of the first data pulses dp2, which is the second leading data pulse among the data pulses supplied to the address electrode groups A, B and D (second address electrode groups). Moreover, the voltage rising period and/or voltage falling period of the first data pulses dp2, which are the second leading data pulse among the data pulses supplied to the address electrode groups A, B and D (second address electrode groups), are approximately the same.

By adjusting the voltage rising period and/or voltage falling period of the data pulses supplied to at least one address electrode group, as already described in detail in FIGS. 16 to 18, thermal damage of each driver, preferably, data driver, for supplying data pulses to each of the address electrode groups can be prevented, and noise generated upon supplying data pulses is reduced.

Although FIG. 18 illustrates only a case in which the number of address electrode groups is four, it is preferred that the number of address electrode groups is 4 to 8 when considering the number of address electrodes X that can be covered by the data driver.

The reason why the number of address electrode groups is 4 to 8 is because if the number of address electrode groups is less than 4, the number of address electrodes X included in each of the address electrode groups becomes excessive.

Accordingly, the electric capacity of the driver, preferably, data driver, for supplying data pulses to the address electrode group including an excessive number of address electrodes X increases in proportion to the number address electrodes X included in the address electrode group having the above electric capacity, so there is a possibility that the cost of the driver may increase.

Furthermore, when a single driver, preferably, data driver, supplies data pulses to the address electrode groups, the magnitude of a displacement current flowing in the driver, preferably, data driver, excessively increases, which may deteriorate the operational stability of the driver, preferably, data driver.

On the contrary, if the number of address electrode groups is more than 8, the number of drivers, preferably, data drivers, for driving a single plasma display panel, excessively increases, thereby increasing the entire manufacturing cost.

As above, in FIG. 18, in order to supply data pulses of different patterns to four different address electrode groups, it is preferred that four different drivers, preferably, data drivers, supply different data pulses to each of the address electrode groups. This will be discussed with reference to FIG. 19.

FIG. 19 is a view for explaining the construction of the driver for supplying data pulses of different patterns to four address electrode groups.

As illustrated in FIG. 19, in a case where the plurality of address electrodes X formed on the plasma display panel 1900 are divided into four address electrode groups, for example, an address electrode group A, an address electrode group B, an address electrode group C and an address electrode group D, the driver 1910 of the plasma display apparatus according to an embodiment of the present invention comprises a first data driver 1911 for supplying data pulses to the address electrode group A, a second data driver 1912 for supplying data pulses to the address electrode group B, a third data driver 1913 for supplying data pulses to the address electrode group C and a fourth data driver 1914 for supplying data pulses to the address electrode group D.

The first, second, third and fourth data drivers 1911, 1912, 1913 and 1914 supply data pulses of different patterns to the address electrode group A, address electrode group B, address electrode group C and address electrode group D.

Meanwhile, referring to FIG. 18, the voltage rising period and/or voltage falling period of the second data pulse dp1, which is the leading data pulse among the data pulses supplied to the address electrode group D, are relatively long, and the voltage rising period and/or voltage falling period of the second data pulse dp2, which is the second leading data pulse among the data pulses supplied to the address electrode group C, are relatively long.

As above, in order to set patterns of data pulses, different operation control signals (ER control signals) are supplied to the fourth data driver 1914 and third data driver 1913 of FIG. 19.

More preferably, the operation control signals (ER control signals) of the energy recovery circuit 1020 included in the data driver having such a construction as I FIG. 10 are supplied to the third data driver 1913 and fourth data driver 1914 at a different point of time.

On the contrary, no different operation control signals (ER control signals) are supplied to the third data driver 1913 and fourth data driver 1914, but a single operation control signal (ER control signal) is delayed a predetermined time, thereby generating the pattern of data pulses as in FIG. 18.

For instance, as in FIG. 19, a single operation control signal (ER control signal) is supplied to the fourth data driver 1914, and the operation control signal supplied to the fourth data driver 1914 is supplied to the third data driver 1913 after being delayed a predetermined time Δt in a first timing controller 1915.

Here, it is assumed that the operation control signal (ER control signal) supplied to the fourth data driver 1914 is a control signal for generating the pattern of data pulses supplied to the address electrode group D of FIG. 18, and the time Δt delayed by the first timing controller 1915 is the time corresponding to one period of data pulses.

Then, in the address electrode group D, the second data pulse, whose voltage rising period and/or voltage falling period are relatively long, is set as the leading data pulse dp1.

Moreover, as the operation control signal (ER control signal) delayed the time Δt by the first timing controller 1915 is supplied to the third data driver 1913, in the address electrode group C, the second data pulse, whose voltage rising period and/or voltage falling period are relatively long, is set as the second leading data pulse dp2.

In this manner, as shown in FIG. 19, a second timing controller 1916 can be further included for delaying the operation control signal (ER control signal) supplied to the second data driver 1912 by the time Δt in comparison with the operation control signal (ER control signal) supplied to the third data driver 1913.

Further, it is needless to say that a third timing controller 1917 can be further included for delaying the operation control signal (ER control signal) supplied to the first data driver 1911 by the time Δt in comparison with the operation control signal (ER control signal) supplied to the second data driver.

As above, once the first, second and third timing controllers 1915, 1916 and 1917 are included, data pulses of such a pattern as in FIG. 18 can be supplied as a single operation control signal (ER control signal) to the address electrode groups A, B, C and D.

Here, the time Δt delayed by the first, second and third timing controllers 1915, 1916 and 1917 can vary to one period, two periods, three periods or the like of data pulses.

Although FIG. 19 illustrates and describes the time Δt delayed by the first, second and third timing controllers 1915, 1916 and 1917 as being equal to each other, it may also be possible to set the time Δt delayed by one or more timing controllers different than the other timing controllers.

For instance, the first timing controller 1915 can delay the operation control signal (ER control signal) by 200 ns (nano seconds), and the second timing controller 1916 can delay the operation control signal by 400 ns (nano seconds).

As described above in detail, the plasma display apparatus according to an embodiment of the present invention prevents thermal/electrical damages of the driver, preferably, data driver, by preventing heat generated in the driver, preferably, data driver, from being concentrated on a specific switching device.

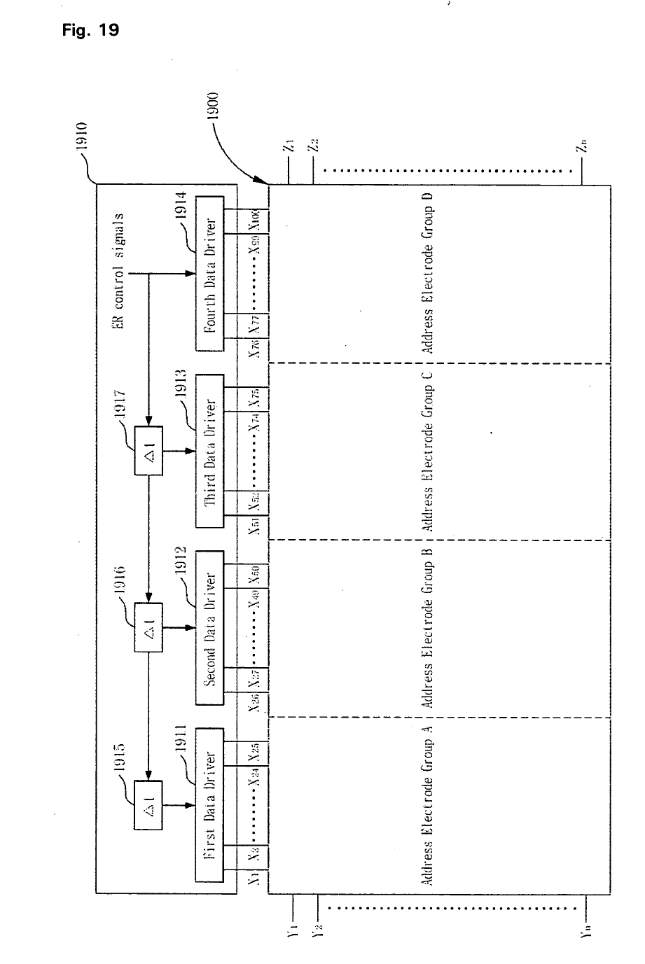

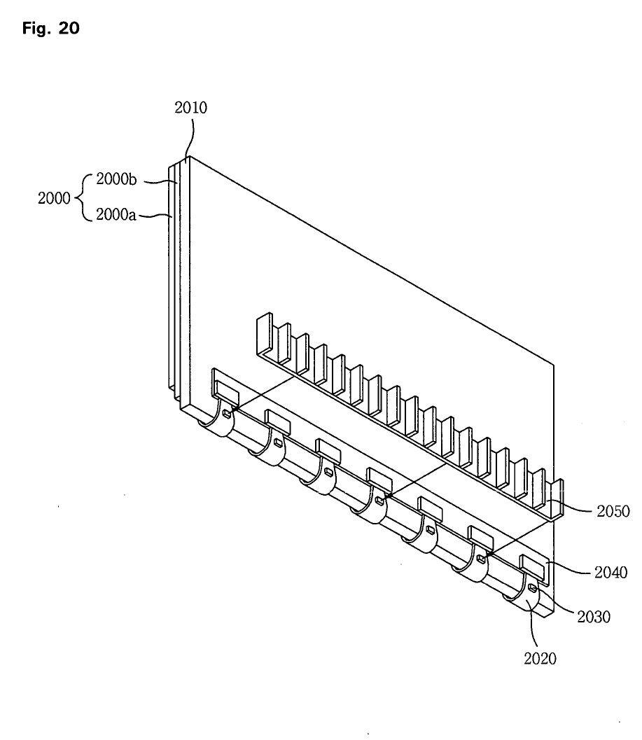

Moreover, a relatively small amount of heat generated in the data driver integrated circuit of the driver, preferably, data driver, of the plasma display apparatus according to an embodiment of the present invention at the time of driving can be effectively released by using a heat sink. An example thereof will be discussed with reference to FIG. 20.

FIG. 20 is a view for explaining one example of a structure employing a heat sink in order to emit heat of the data driver integrated circuit upon driving the plasma display apparatus according to an embodiment of the present invention.

FIG. 20 illustrates only an example of a structure for releasing heat generated from the data driver integrated circuit in the plasma display apparatus in accordance with the present invention, and it should be noted that the present invention is not limited to the structure of FIG. 20.

Referring to FIG. 20, a front panel 2000a and a rear panel 2000b are joined together, and though not shown, a frame 2010 is disposed on the rear surface of the plasma display panel 2000 where a plurality of address electrodes X are formed.

On the frame 2010, a data board 2040 for supplying a driving voltage to the address electrodes X formed on the plasma display panel 2000 is disposed.

Here, a film type device is used in order to electrically connect the data board 2040 disposed on the frame 2010 and the address electrodes X formed on the plasma display panel 2000.

More preferably, a tape carrier package (TCP), which is one of film type devices 2020, is used.

Here, a data driver integrated circuit 2030 (Data IC) is mounted on the film type device 2020.

The data driver integrated circuit 2030 carries out a switching operation in order to apply a data voltage Vd and a bias voltage Vb to the address electrodes X formed on the plasma display panel 2000 according to a driving signal generated from the driver, preferably, data driver.

In the data driver integrated circuit 2030 carrying out a switching operation in order to supply a data voltage Vd and a bias voltage Vb in the plasma display apparatus according to an embodiment of the present invention, the amount of heat generated upon driving is relatively small as compared to a conventional data driver integrated circuit. This has been already discussed in detail in the above description.

To release heat of the data driver integrated circuit 2030 according to an embodiment of the present invention that generates a relatively small amount of heat as compared to the conventional art, it is more preferred to use a heat sink 2050.

The reason thereof is that it is more advantageous in terms of operational stability to release the heat generated from the data driver integrated circuit out of the data driver integrated circuit even if the data driver integrated circuit of the plasma display apparatus according to an embodiment of the present invention generates a relatively small amount of heat as compared to the conventional art.

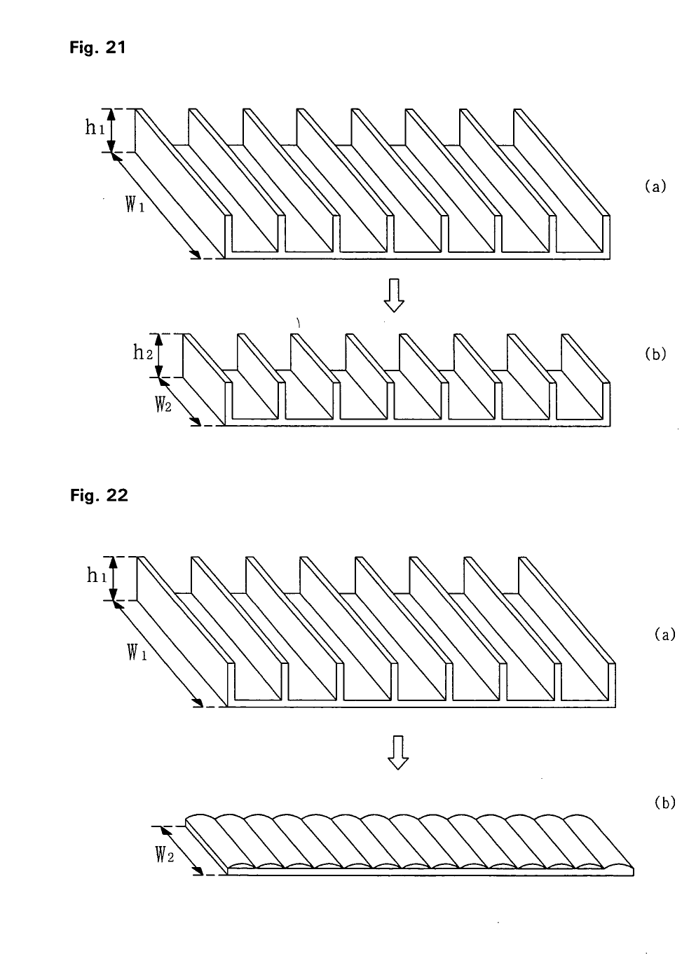

As above, it does not matter even if the heat sink 2050 for releasing out the heat generated from the data driver integrated circuit 2030 of the plasma display apparatus according to an embodiment of the present invention is smaller in volume than the conventional one. This will be discussed with reference to FIGS. 21 and 22.

FIG. 21 is a view for explaining one example of a structure of a heat sink for releasing heat generated from the data driver integrated circuit of the plasma display apparatus according to an embodiment of the present invention.

FIG. 22 is a view for explaining another example of a structure of a heat sink for releasing heat generated from the data driver integrated circuit of the plasma display apparatus according to an embodiment of the present invention.

Firstly, referring to FIG. 21, (a) shows a heat sink for releasing out the heat generated from the data driver integrated circuit of the conventional plasma display apparatus.

Regarding (a), the heat sink for releasing out the heat generated from the data driver integrated circuit according to the conventional art has a horizontal width of W1, and the height of a single heat release fin is h1.

The heat release efficiency of the heat sink releasing the heat generated from the data driver integrated circuit increases in proportion to the volume of the heat sink or the surface area of the heat sink.

On the contrary, (b) shows a heat sink for releasing out the heat generated from the data driver integrated circuit of the plasma display apparatus according to an embodiment of the present invention.

Regarding (b), the heat sink for releasing out the heat generated from the data driver integrated circuit according to the present invention has a horizontal width of W2, and the height of a single heat release fin is h2.

Here, the relation of W2<W1 and h2<h1 is established.

That is, the size of the heat sink for releasing out the heat generated from the data driver integrated circuit of the plasma display apparatus according to an embodiment of the present invention is smaller than that of the conventional art.

More concretely, the surface area and/or volume of the heat sink of (b) is smaller than the surface area and/or volume of the heat sink of (a).

The reason why the surface area and/or volume of the heat sink used in the plasma display apparatus according to an embodiment of the present invention becomes smaller than that of the conventional art as in (a) because the heat generated from the data driver integrated circuit is substantially reduced as compared to the conventional art as the heat generated upon driving is not concentrated but distributed over a specific switching device, preferably, the data driver integrated circuit, in the plasma display apparatus according to an embodiment of the present invention.

In this manner, the volume and surface area of the heat sink used in the plasma display apparatus according to an embodiment of the present invention becomes smaller as compared to the conventional art, and accordingly the entire manufacturing cost can be largely reduced.

Next, referring to FIG. 22, (a) shows a heat sink for releasing out the heat generated from the data driver integrated circuit of the conventional plasma display apparatus in the same manner as in (a) of FIG. 21.

On the contrary, (b) shows an example of another structure of a heat sink for releasing out the heat generated from the data driver integrated circuit of the plasma display apparatus according to an embodiment of the present invention as shown in FIG. 10.

Regarding (b), the heat sink for releasing out the heat generated from the data driver integrated circuit according to the embodiment of the present invention has a horizontal width of W2, which is smaller than W1 of (a), and the heat release fin shown in (a) is omitted.

But, a curve is formed on the surface of the heat sink of (b).

The reason why the heat release fin in the heat sink used in the plasma display apparatus according to an embodiment of the present invention is omitted because the heat generated from the data driver integrated circuit is substantially reduced as compared to the conventional art.

Subsequently, by adding an energy recovery circuit to a driver for supplying data pulses, preferably, a data driver, and driving the same, the present invention can improve operational stability of the entire plasma display apparatus by preventing heat generated upon driving from being concentrated on a specific switching device, preferably, a data driver integrated circuit and preventing thermal and electrical damages of the data driver integrated circuit.

Furthermore, the present invention can lower manufacturing costs by enabling a stable operation even if the withstand voltage characteristics of the data driver integrated circuit are lowered,

Furthermore, the present invention can lower manufacturing costs because the volume and/or surface area of a heat sink for releasing heat generated from the data driver integrated circuit can be relatively smaller when compared with the conventional art.

The invention being thus described, it will be obvious that the same may be varied in many ways, Such variations are not to be regarded as a departure from the spirit and scope of the invention, and all such modifications as would be obvious to one skilled in the art area intended to be included within the scope of the following claims.

What is claimed is:

1. A plasma display apparatus, comprising:
a panel comprising a plurality of address electrodes; and
a driver for applying a first data pulse and a second data pulse, which are different from each other, to the plurality of address electrodes.

2. The plasma display apparatus as claimed in claim 1, wherein the first data pulse and the second data pulse are applied in the same subfield.

3. The plasma display apparatus as claimed in claim 1, wherein the voltage rising period and/or falling period of the second data pulse is more than the voltage rising period and/or falling period of the first data pulse.

4. A plasma display apparatus, comprising:
a panel comprising a plurality of address electrodes; and
a driver for applying data pulses to a plurality of address electrode groups, into which the plurality of address electrodes are divided, and making a N-th (N is a natural number) data pulse among the data pulses supplied to at least one of the address electrode groups different from a N-th data pulse among the data pulses supplied to the other address electrode groups.

5. The plasma display apparatus as claimed in claim 4, wherein the N-th (N is a natural number) data pulse among the data pulses supplied to at least one of the address electrode groups and the N-th data pulse among the data pulses supplied to the other address electrode groups are applied in different subfields.

6. The plasma display apparatus as claimed in claim 4, wherein the voltage falling period and/or rising period of the N-th (N is a natural number) data pulse among the data pulses supplied to at least one of the address electrode groups is different from the voltage falling period and/or rising period of the N-th data pulse among the data pulses supplied to the other address electrode groups.

7. The plasma display apparatus as claimed in claim 6, wherein the voltage rising period of the N-th (N is a natural number) data pulse among the data pulses supplied to at least one of the address electrode groups is the time taken for the voltage of the data pulse to rise from 10% of the highest voltage to 90% of the highest voltage, and the voltage falling period of the N-th (N is a natural number) data pulse among the data pulses supplied to at least one of the address electrode groups is the time taken for the voltage of the data pulse to fall from 90% of the highest voltage to 10% of the highest voltage.

8. The plasma display apparatus as claimed in claim 4, wherein the plurality of address electrode groups each comprises the same number of address electrodes.

9. The plasma display apparatus as claimed in claim 4, wherein the number of address electrode groups ranges from four to eight.

10. The plasma display apparatus as claimed in claim 4, wherein the number of address electrode groups equals M (M is a natural number of two or more), and the voltage falling period and/or rising period of the N-th (N is a natural number) data pulse among the data pulses supplied to one of the M number of address electrode groups is different from the voltage falling period and/or rising period of the N-th data pulse among the data pulses supplied to the other M−1 number of address electrode groups.

11. The plasma display apparatus as claimed in claim 10, wherein the voltage falling period and/or rising period of the N-th (N is a natural number) data pulse among the data pulses supplied to one of the M number of address electrode groups is more than the voltage falling period and/or rising period of the N-th data pulse among the data pulses supplied to the other M−1 number of address electrode groups.

12. The plasma display apparatus as claimed in claim 6, wherein the address electrode groups comprises a first address electrode group and a second address electrode group, and the voltage falling period and/or rising period of the N-th data pulse among the data pulses supplied to the first address electrode group is more than the voltage falling period and/or rising period of the N-th data pulse among the data pulses supplied to the second address electrode group.

13. The plasma display apparatus as claimed in claim 12, wherein the voltage falling period and/or rising period of the N-th data pulse among the data pulses supplied to the first address electrode group is substantially equal to the voltage falling period and/or rising period of sustain pulses supplied to sustain electrodes in a sustain period after the address period

14. The plasma display apparatus as claimed in claim 12, wherein the voltage falling period and/or rising period of the N-th data pulse among the data pulses supplied to the first address electrode group are different from each other.

15. The plasma display apparatus as claimed in claim 4, wherein the voltage falling period and/or rising period of the N-th data pulse among the data pulses supplied to the first address electrode group are substantially equal to each other.

16. A method for driving a plasma display apparatus, comprising the steps of:
applying a first data pulse and a second data pulse different from the first data pulse to an address electrode during an address period; and
applying sustain pulses to sustain electrodes after the address period.

17. The method as claimed in claim 16, wherein the first data pulse and the second data pulse are applied in the same subfield.

18. The method as claimed in claim 16, wherein the voltage rising period and/or falling period of the first data pulse is different from the voltage rising period and/or falling period of the second data pulse.

19. The method as claimed in claim 18, wherein the voltage rising period and/or falling period of the second data pulse is more than the voltage rising period and/or falling period of the first data pulse.

20. The method as claimed in claim 18, wherein the voltage rising period of the second data pulse is the time taken for the voltage of the data pulse to rise from 10% of the highest voltage to 90% of the highest voltage, and the voltage falling period of the second data pulse is the time taken for the voltage of the data pulse to fall from 90% of the highest voltage to 10% of the highest voltage.
